(19) United States
(12) Patent Application Publication
(10) Pub. No.: US 2005/0136146 A1
(43) Pub. Date: Jun. 23, 2005

(54) Apparatus for automated method of injecting polymer to form a graphical design onto substrates

(76) Inventor: Phong Pham, La Porte, TX (US)

Correspondence Address: McFatridge, Baker & Deen, P.C., 3900 Essex Ln., #730, Houston, TX, 77027, US

(21) Appl. No.: 10/742,013

(22) Filed: Dec. 18, 2003

(51) Int. Cl. B29C 45/14

(52) U.S. Cl. 425/129.1; 425/127; 425/143; 425/543

(57) ABSTRACT

An apparatus for an automated method of injecting thermosetting polymers onto substrates includes a controllable back plate to move said substrate to the desired location for applying the polymer whereas the integrated pressure system delivers a predetermined amount of the polymeric material through a chilled transfer line adapted through a set of thermally insulated die press members and a set of heated die press members where a necessary amount of heat is transferred to raise the temperature of the previously chilled polymeric material to a specified curing temperature, applying to the substrate with at least one automated molding device, at least one polymer supply and a control system for controlling the operation of the molding devices and polymer supplies.

### BACKGROUND OF THE INVENTION

1. Field of the Invention

This invention relates generally to an apparatus for an automated method of injecting thermosetting polymers, and more particularly to an apparatus for generating graphical designs using moldable thermosetting polymers onto substrates.

2. Background

The use of textural displays, namely logos and other types of graphical displays, on articles of clothing is popular and widely applicable. Currently, the production of such graphic media is generally limited to two-dimensional display media such as silkscreen, embroidering or direct printing. In order to develop new market for their products, marketers of consumer goods are seeking innovative ways to display graphic designs. The present invention is directed to one of the innovative means to produce a display of a variety of three-dimensional forms.

### SUMMARY OF THE INVENTION

One aspect of the present invention is a die set with a plurality of die members for use in an injection device for molding at least one three-dimensional body of a thermosetting polymer onto at least one substrate is provided that includes a receiving die member adapted to receive and distribute at least one supply of polymer, a thermal isolation die member, and a mold die member adapted to receive a distribution of at least one polymer and mold at least one body of the polymer onto a substrate. The die members are structurally coupled by rigid guide pins and fasteners to maintain integrity during the injection process.

### BRIEF DESCRIPTION OF THE DRAWINGS

FIG. 1 is an illustration of a preferred embodiment of an apparatus 60 for molding multi-colored three-dimensional bodies of silicone, or some other thermosetting polymer, onto a plurality of articles of clothing, or some other substrate comprising a molding device 70, a die set 75, a vertical hydraulic actuator 1, a plurality of steel rods 2A and 2B, a hydraulic actuator sliding fixture 3, air cylinders 4A and 4B, a die holder 5, a receiving die member 9, a thermal isolation member 10, a mold die member 11, a plurality of back plates 6A and 6B, a plurality of sliding fixtures 7A and 7B, a plurality of sliding track members 8A, 8B, 8C and 8D, a steel frame 17, a cabinet door 18, a plurality of conventional control switches 16A and 16B, a chiller 14, a hydraulic system 15, a silicone resin supply system 80, a silicone supply conduit system 85, a plurality of silicone pumps 22A and 22B, a plurality of silicone resin supplies 21A and 21B, a silicone conduit manifold 19, a control system 90, a touch screen monitor 12, and a programmable logic controller (PLC) 13;

FIG. 2 is a detailed perspective view showing components of a preferred embodiment of an automated device for positioning horizontally the die set comprising a hydraulic actuator sliding fixture 3 adapted to mount on two air cylinders 4A and 4B, which are guided by two rails 23A and 23B, and to die holder 5;

FIG. 3 is a detailed perspective view showing components of a preferred embodiment of an automated device for positioning horizontally a substrate 57 comprising a plurality of back plates 6A and 6B adapted to be mounted on sliding fixtures 7A and 7B, a plurality of air cylinders 24A and 24B to provide lateral motion, a plurality of sliding track members 8A, 8B, 8C and 8D, and a plurality of sliding blocks 25A, 25B, 25C and 25D;

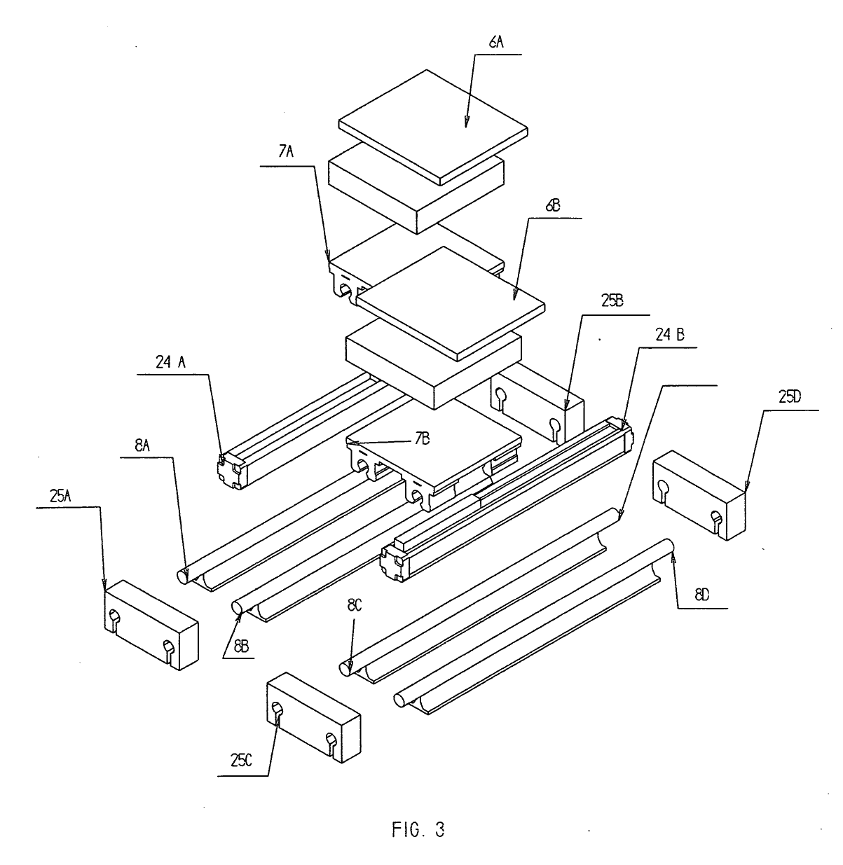

FIG. 4 is a detailed perspective view showing components of a preferred embodiment of an automated device for positioning horizontally a single back plate 6A;

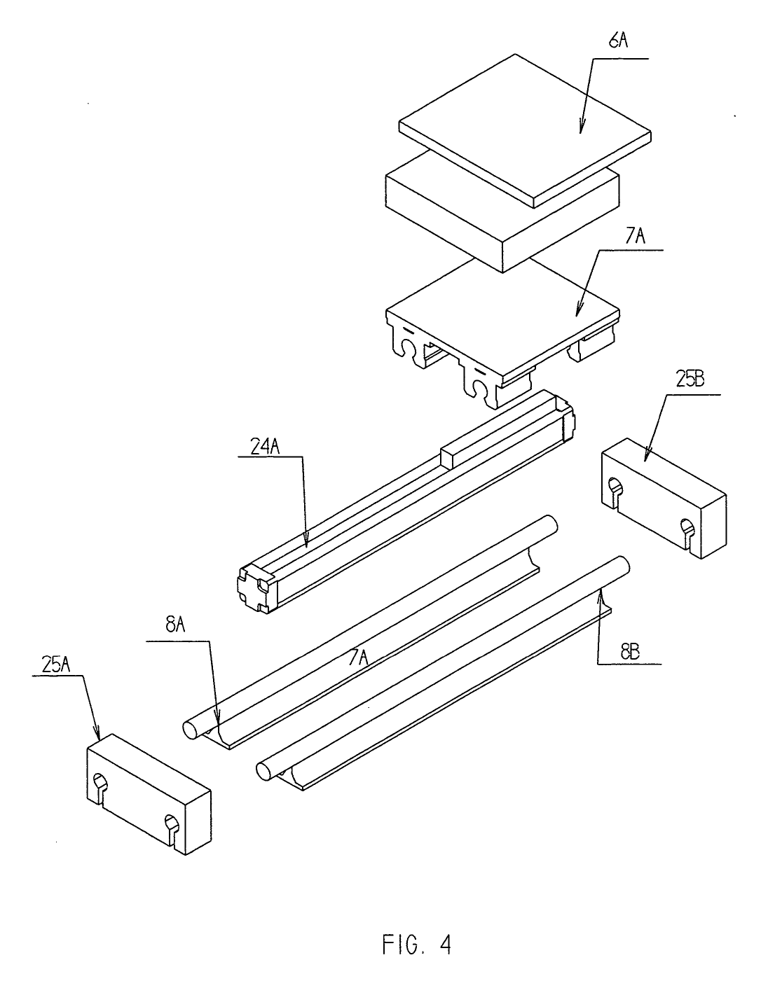

FIG. 5 is a detailed perspective view showing components of a preferred embodiment of an automated device for positioning horizontally a single back plate 6B;

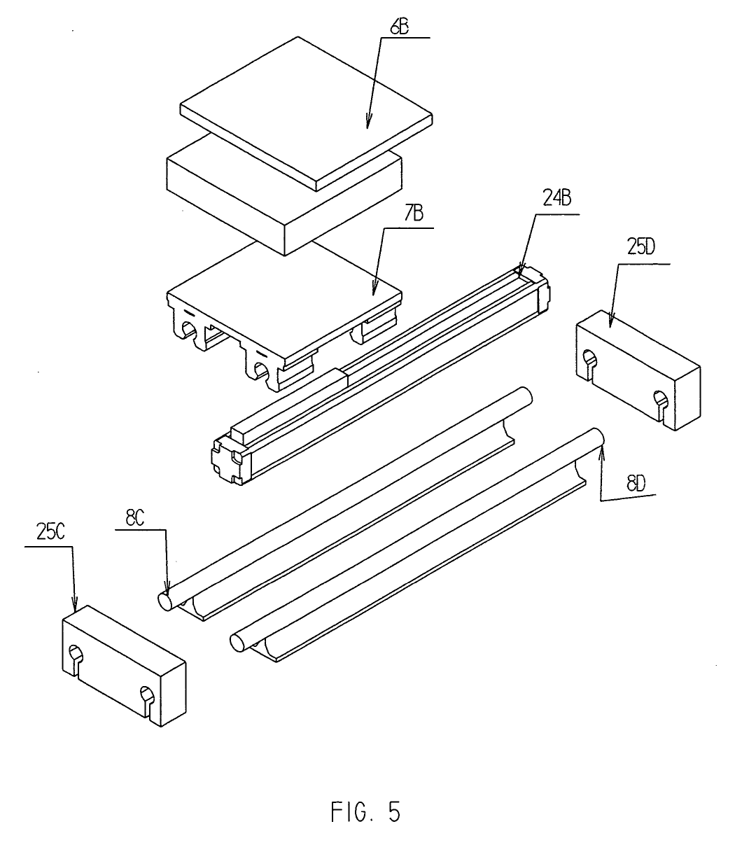

FIG. 6 is an assembled perspective view of the automated device of FIG. 3 engaging the back plates 6A and 6B at various stages of operation and supported by a supporting member 34;

FIG. 7 is an assembled perspective view of the automated device of FIG. 2 engaging a die holder 5 for positioning in relation to the back plate 6A or 6B and supported by supporting members 33A and 33B;

FIG. 8 is a detailed perspective view of the preferred embodiment of FIG. 1 without the silicone resin supply system 80;

FIG. 9 is a detailed view of the vertical hydraulic actuator 1 for moving vertically the die holder 5 in FIG. 2;

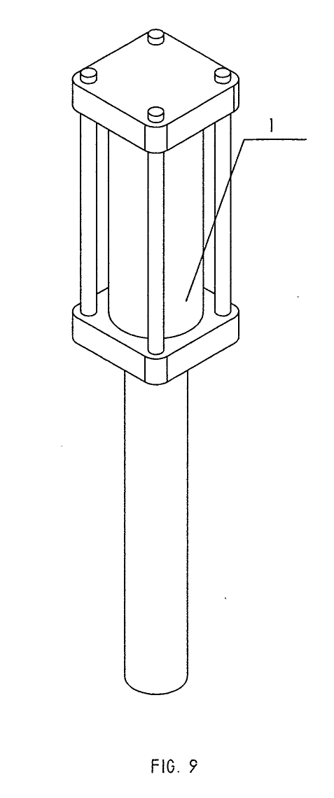

FIG. 10 is a detailed view of two steel rods 2A and 2B for guiding and supporting the hydraulic actuator 1 in FIG. 2;

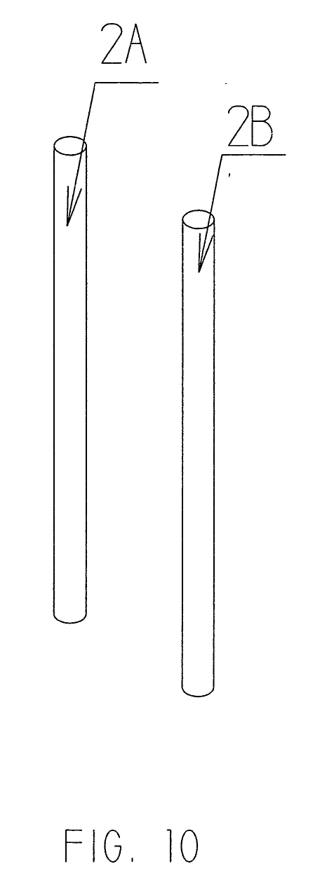

FIG. 11 is a detailed view of a sliding fixture 3 for the hydraulic actuator 1 and the steel rods 2A and 2B in FIG. 2;

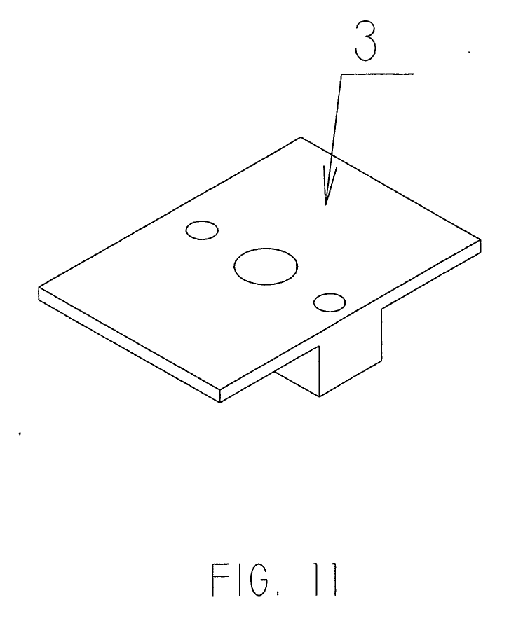

FIG. 12 is a partial view of two air cylinders 4A and 4B for moving horizontally the hydraulic actuator 1 in FIG. 2;

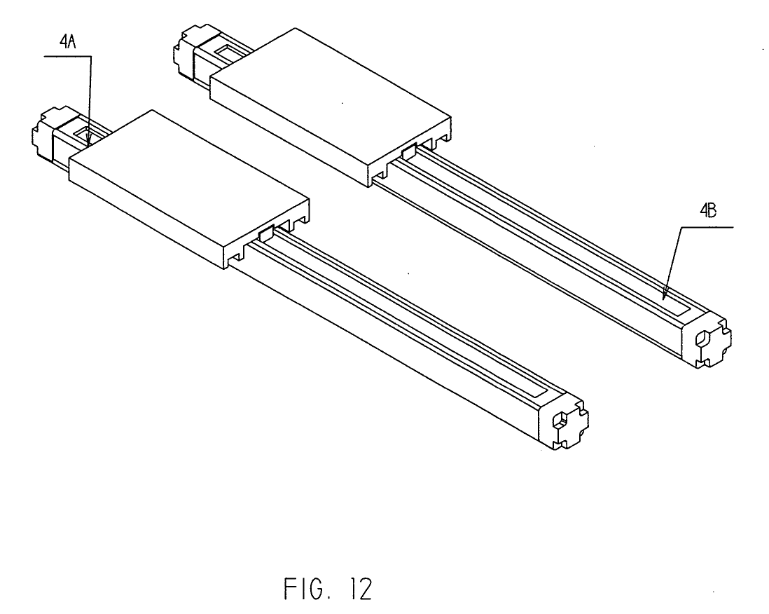

FIG. 13 is a detailed view of two horizontal rails 23A and 23B for guiding and positioning the air cylinders 4A and 4B in FIG. 2;

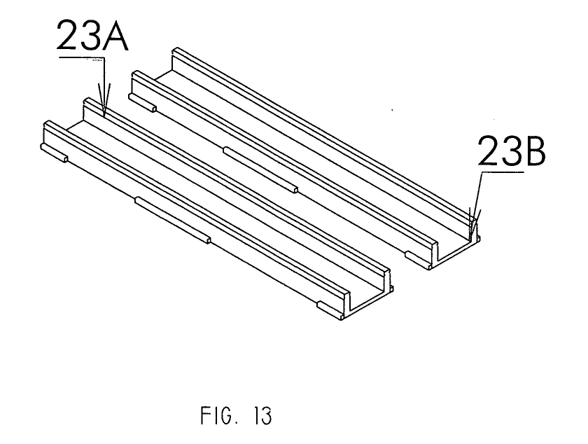

FIG. 14 is a detailed view of the die set holder 5;

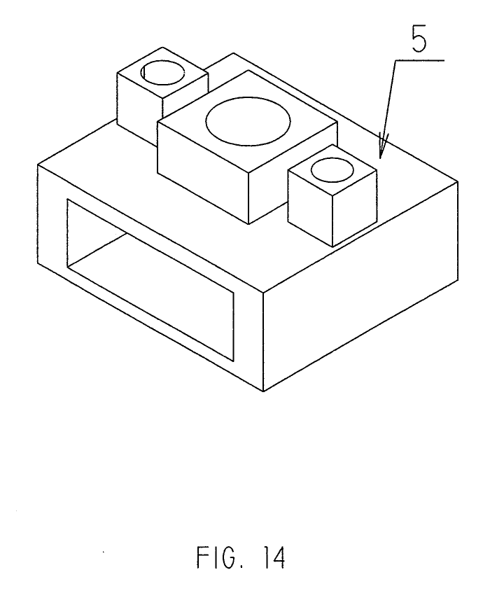

FIG. 15 is a detailed view of two back plates 6A and 6B for supporting and positioning substrate;

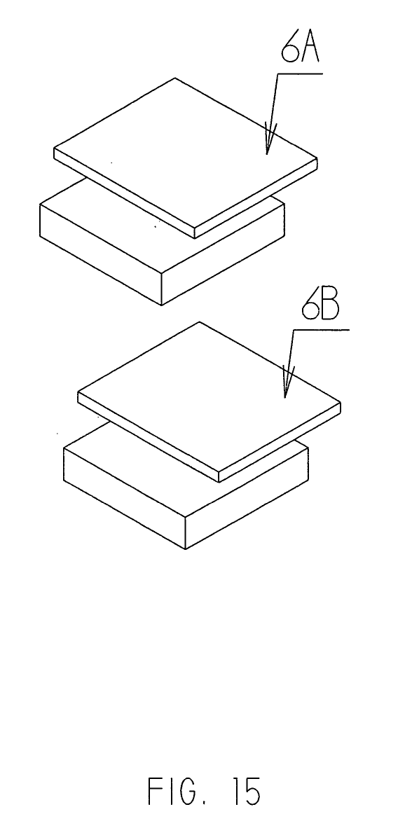

FIG. 16 is detailed view of two sliding fixtures 7A and 7B for supporting and positioning the back plates 6A and 6B;

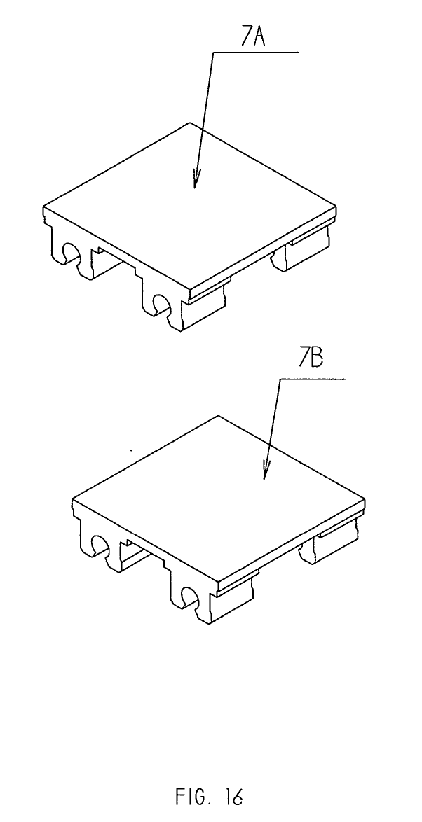

FIG. 17 is a detailed view of two air cylinders 24A and 24B for moving horizontally the back plates 6A and 6B;

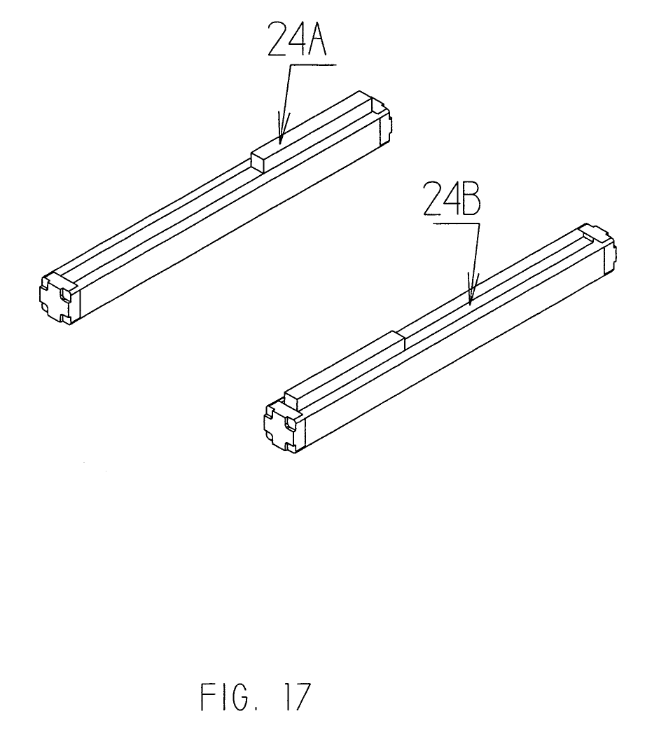

FIG. 18 is a detailed view of four sliding track members 8A, 8B, 8C and 8D for supporting sliding fixtures 7A and 7B in FIG. 4;

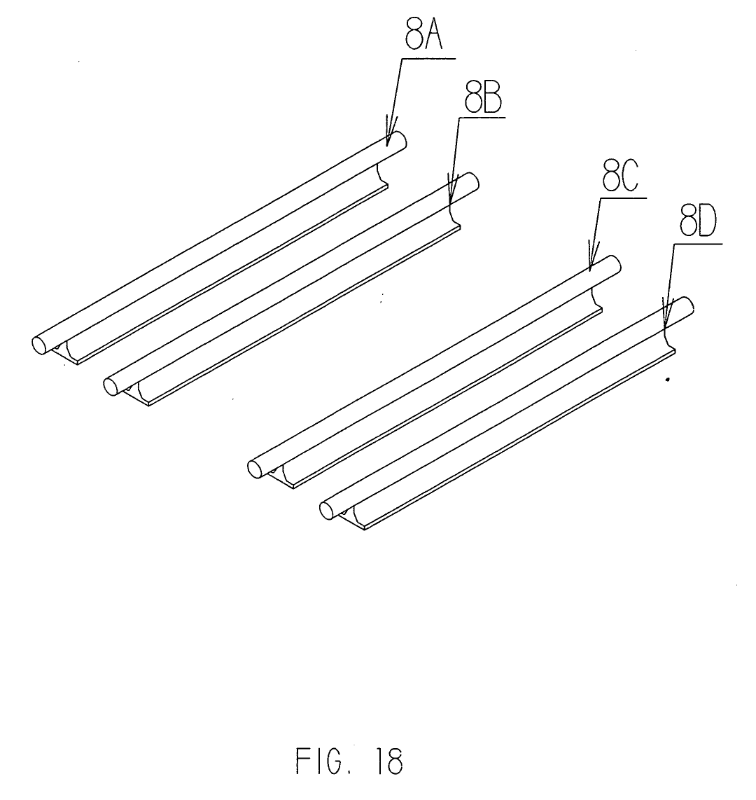

FIG. 19 is a detailed view of four sliding blocks 25A, 25B, 25C and 25D for stopping and positioning sliding fixtures 7A and 7B in FIG. 4;

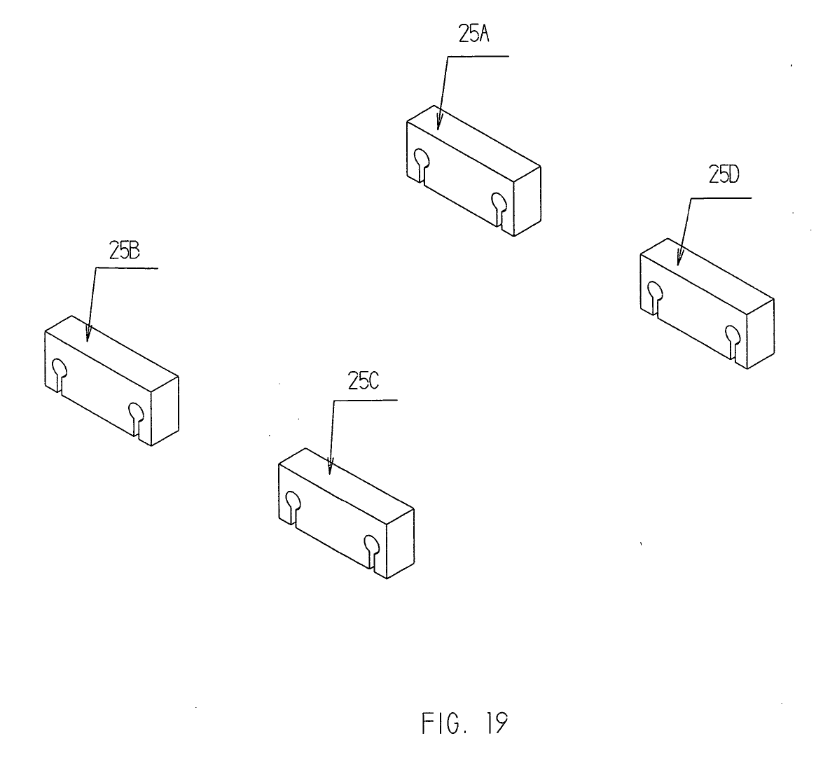

FIG. 20 illustrates a control system for the preferred embodiment of the of FIG. 1 including a touch screen monitor 12 and PLC 13;

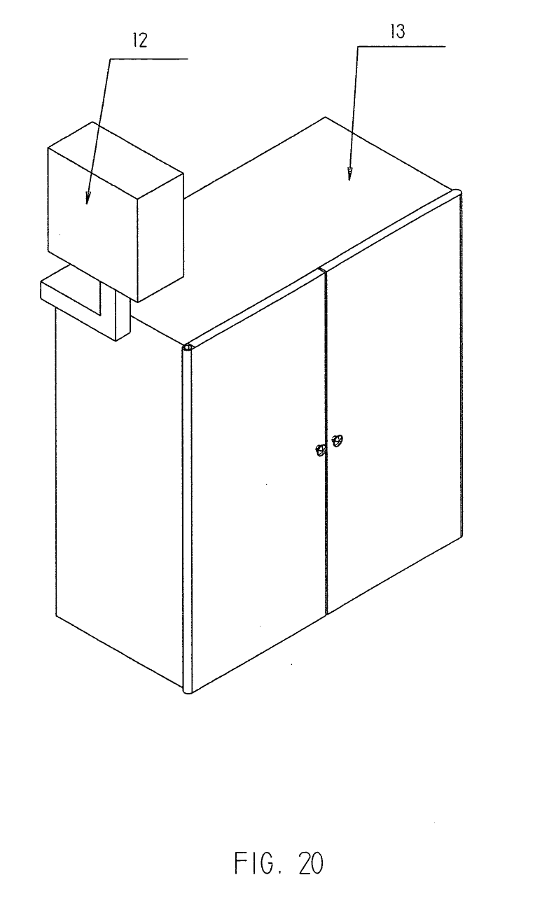

FIG. 21 illustrates a supporting frame for the molding apparatus 60 of FIG. 1 and showing two manual control switches 16A and 16B for starting and shutting off the automated process of injecting polymer;

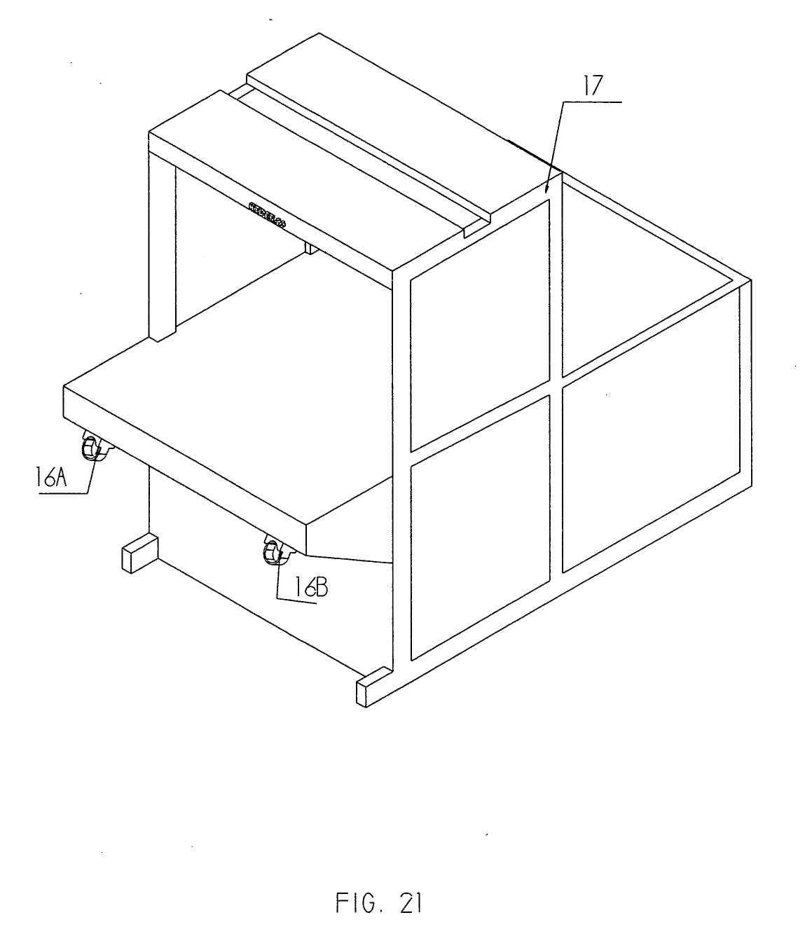

FIG. 22 illustrates a hydraulic delivery system for the hydraulic actuator 1 with a hydraulic system 15;

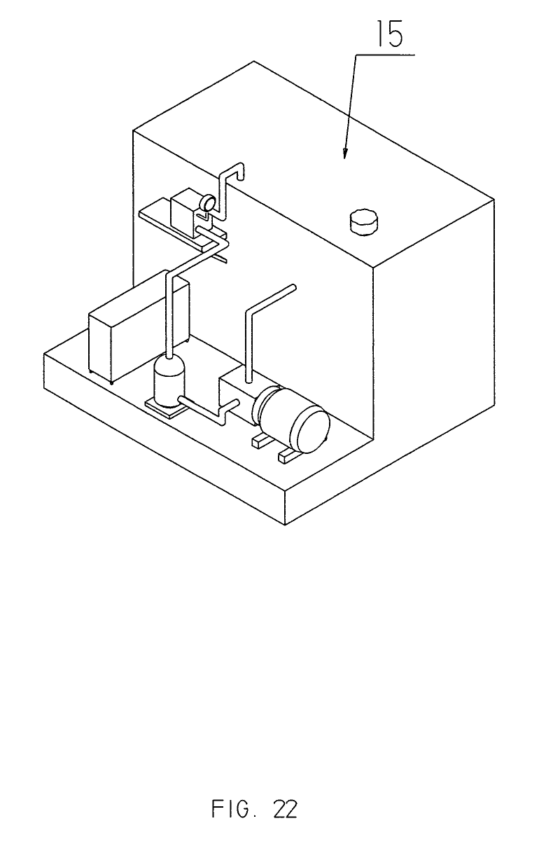

FIG. 23 is a detailed view of the silicone injection pumps (injector) 26A, 26B, 26C and 26D for use in the production of four colors graphic design;

FIG. 24 is a detailed view of the pistons 27A, 27B, 27C and 27D which are shown independently removed from the assembly of the silicone injection cylinders of the injection pumps 26A, 26B, 26C and 26D of FIG. 23;

FIG. 25 is a detailed view of the cabinet doors 18A and 18B of the cabinet enclosure of FIG. 8;

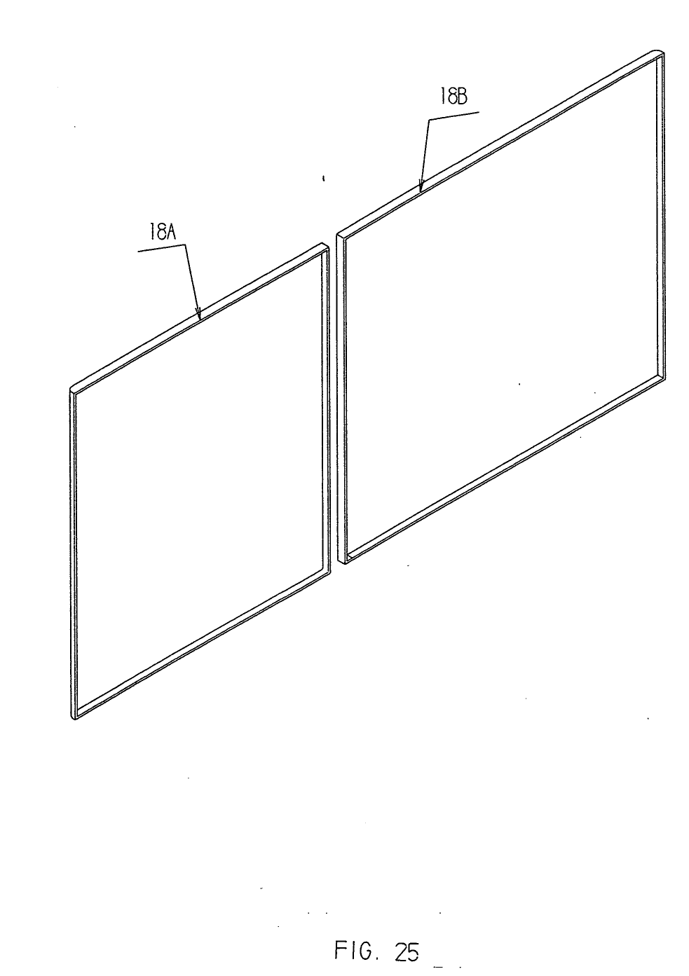

FIG. 26 is a perspective view of an assembly of hydraulic actuated injection valves 30A, 30B, 30C, 30D and 30E independently coupled to hydraulic valve manifold 29 to operate silicone injection pumps 26A, 26B, 26C, 26D and hydraulic actuator 1 of FIG. 8;

FIG. 27 is a detailed view of the collars 28A, 28B, 28C and 28D to support and control the operation of the injection pistons 27A, 27B, 27C and 27D of the FIG. 8;

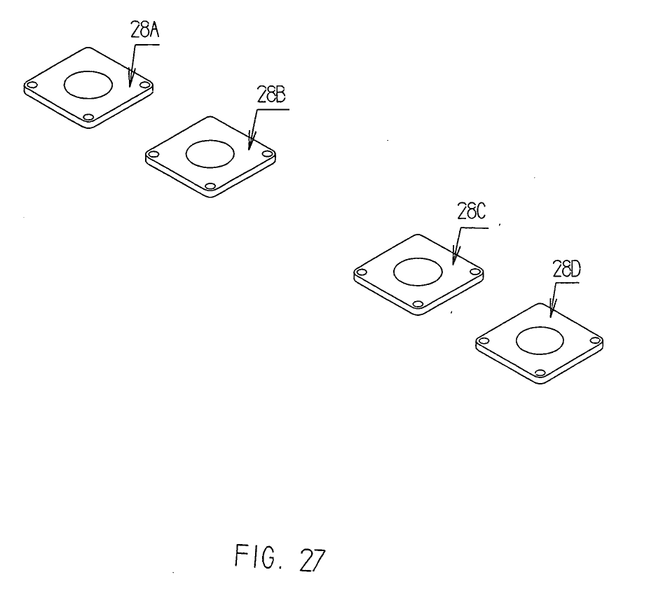

FIG. 28 is a perspective view of an assembly of air valves 32A, 32B, 32C, 32D and 32E independently coupled to air valve manifold 31 to operate air cylinders 4A, 4B, 24A and 24B of FIG. 8;

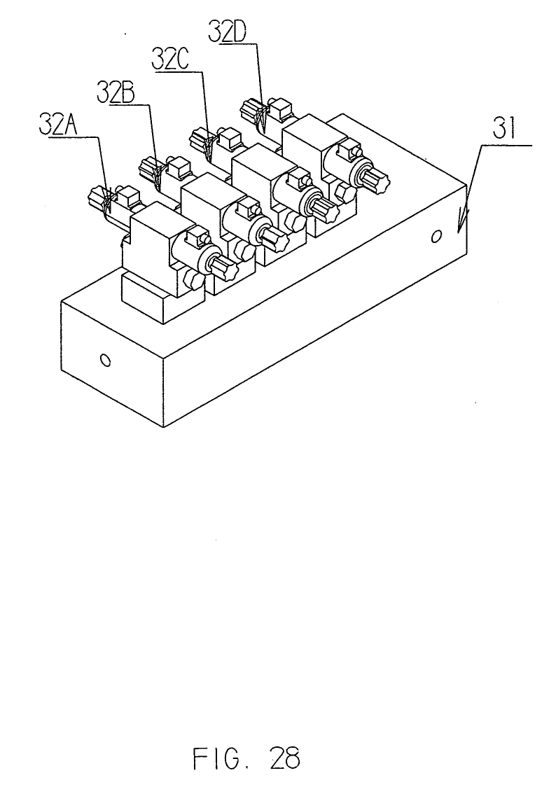

FIG. 29 is a fragmentary perspective view of die members comprising a receiving die member 9 with IN and OUT chilled water connection and plug 35, a thermal isolation die member 10, a mold die member 11 with die cavity 36, two heaters 37A and 37B, and a temperature sensor 38 in communication with PLC 13 in FIG. 1, bolts 39A, 39B, 39C and 39D connect the die members 9, 10 and 11 to die holder 5, and dowel pins 40A and 40B direct and hold the alignment of the die members;

FIG. 30 is a detailed perspective view of FIG. 29 showing die holder 5 in relation to the receiving die member 9, the thermal isolation die member 10, the mold die member 11 and the coupling pattern;

FIG. 31 is a sectional perspective view of the preferred embodiment of the die set 75 as the mold die member 11 closes in to the garment 57 as supported by back plate 6 within an air gap 50 allowing gas and air to vent and further comprises of injection nozzles 41A, 41B, 41C and 41D with nozzle tips 52A, 52B, 52C and 52D connecting to injection lines 42, 43, 44 and 49 delivering corresponding polymeric material 45, 46, 47 and 48 into the peripheral space of the graphical design 59 in FIG. 32 adapted to discrete design portions located apart;

FIG. 32 is a frontal view of the outside surface of the improved garment 57 comprised of a graphical design 59 in FIG. 32 with discrete design elements 59A, 59B, 59C, 59D and 59E.

FIG. 33 illustrates the preferred embodiment of the apparatus 60 for injecting polymer onto a substrate, namely a garment 57, with the integrated back plates 6A and 6B mounted on movable and controllable sliding fixtures 7A and 7B, die holder 5, and the degrees of movement are being shown by arrows;

FIG. 34 is a perspective view illustrating the present invention and particularly the production a graphical design on substrate, namely garments 57A and 57B, by lowering the die holder 5 into a defined position, releasing the die holder 5 and then delivering the finished garment 57 externally from the die set 75 in FIG. 31;

FIG. 35 is a schematic diagram of the injection for delivering four (4) discrete colored polymeric materials comprising metered injectors 26A, 26B, 26C and 26D connecting to corresponding block valves 54A, 54B, 54C and 54D and chilled injection lines 55A, 55B, 55C and 55D, and subsequently connecting to the corresponding manifolds 56A, 56B, 56C and 56D where the polymeric materials spirally flow through;

FIG. 36 is a perspective view of the apparatus 60 in FIG. 1 and FIG. 8;

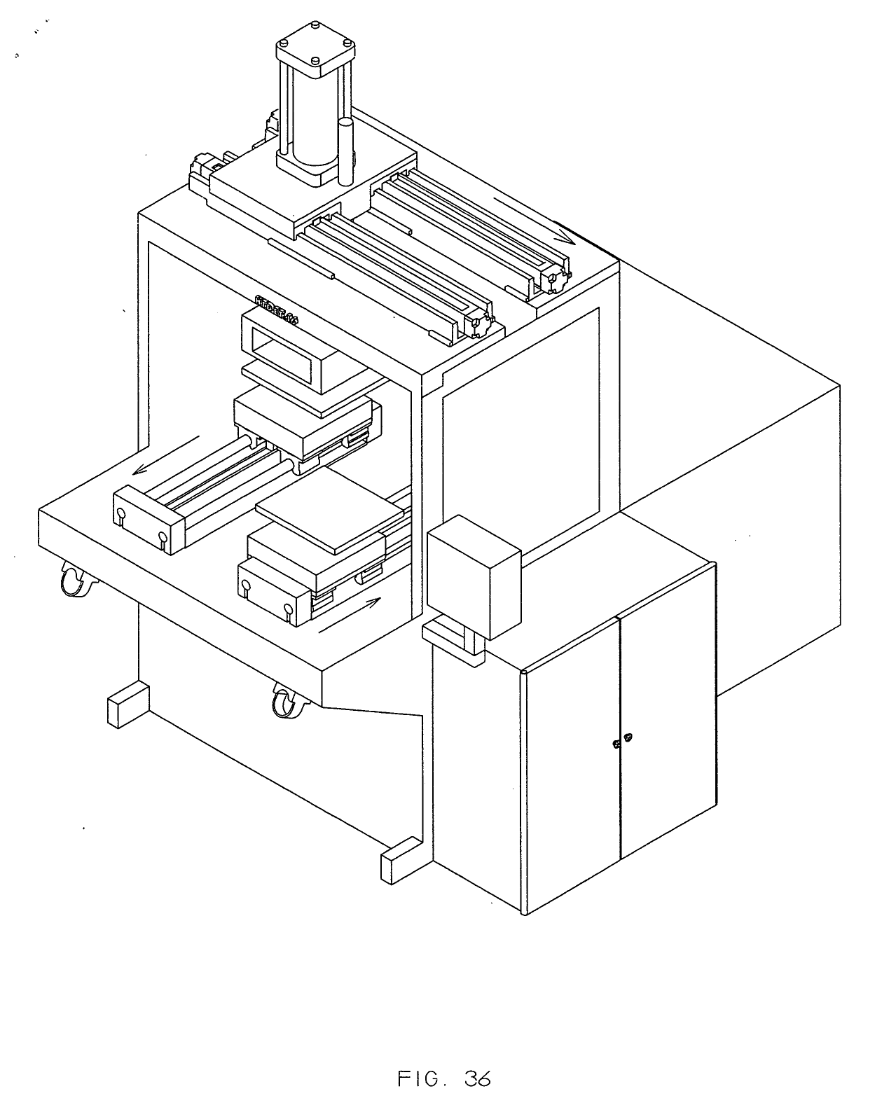

FIG. 37 is a detailed view of the removable injection nozzles 41A, 41B, 41C and 41D.

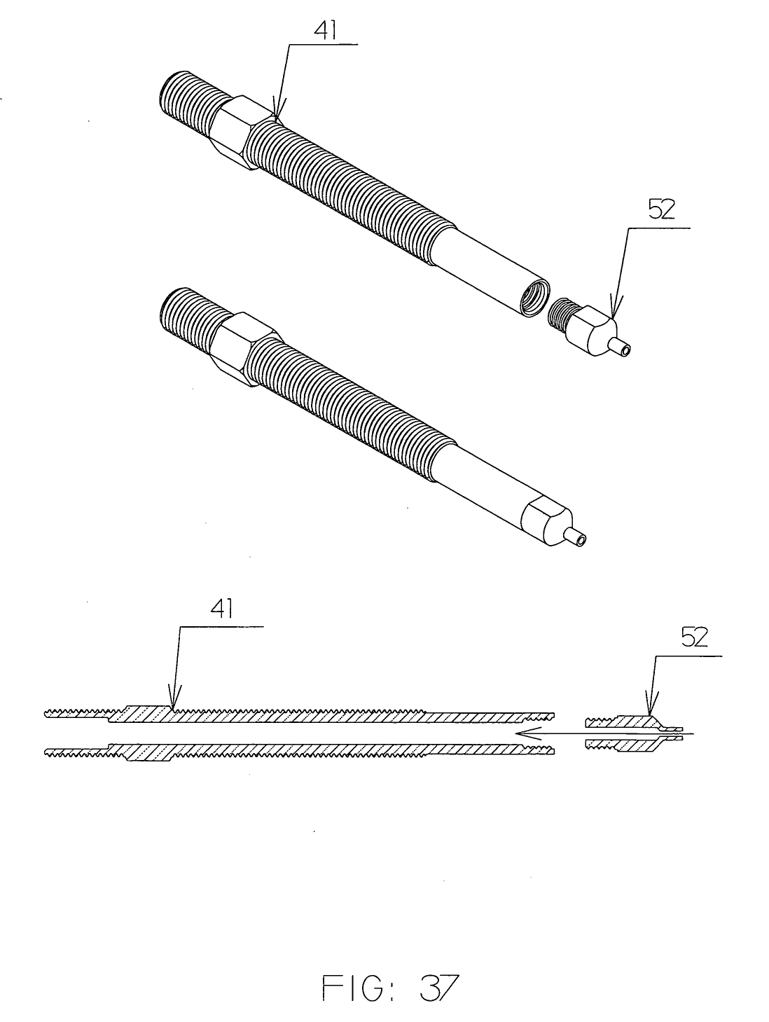

### DESCRIPTION OF THE PREFERRED EMBODIMENTS

An apparatus 60 for molding silicone onto garments 57 is provided that permits a plurality of multi-colored, three-dimensional bodies of silicone to be placed upon and permanently affixed to a plurality of articles of clothing. More generally, the apparatus 60 may be applied to the application of silicone moldings onto other substrates including cloth, paper, cardboard, wood, leather, wire mesh, sponge or foam rubber. More generally still, the teachings of the present disclosure may also be applied to the application of three-dimensional molded bodies using other commercially available thermosetting polymers including silicone, nitrile rubber, or urethane onto other substrates including cloth, paper, cardboard, wood, leather, wire mesh, sponge or foam rubber. More generally still, the teachings of the present disclosure may be applied to the application of a plurality of three-dimensional bodies of a plurality of various thermosetting polymers onto substrates including silicone, nitrile rubber or urethane. Therefore, the disclosure of preferred embodiments for molding three-dimensional bodies of silicone onto garments 57 is meant to be illustrative and not limiting.

An apparatus 60 for encapsulating elements within three-dimensional bodies of silicone is also provided that permits one or more elements to be encapsulated within a three-dimensional body of silicone. More generally, the method and apparatus 60 may be applied to the encapsulation of one or more elements into three-dimensional bodies of any number of thermosetting polymers such as, for example, silicone, urethane or nitrile rubber. Therefore, the disclosure of preferred embodiments for encapsulating elements into three-dimensional bodies of silicone is intended to be illustrative and not limiting.

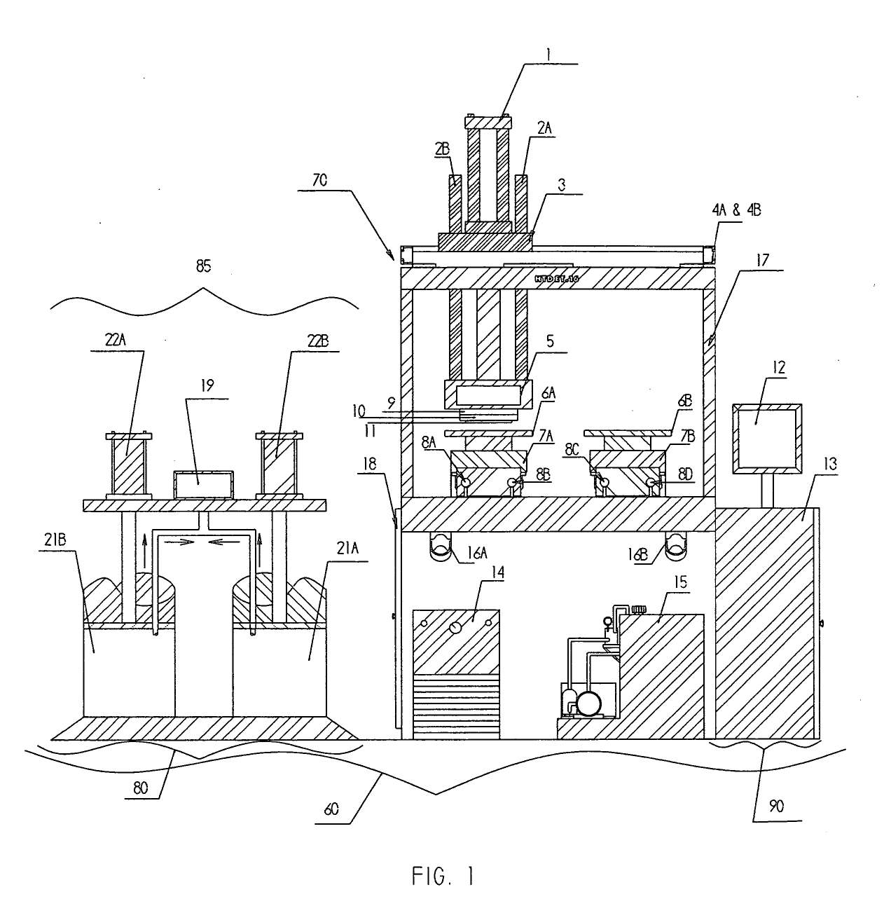

Referring to FIG. 1, the illustration describes one of the preferred embodiments of the invention for an apparatus 60 for molding three-dimensional bodies of silicone onto an article of clothing. The apparatus 60 includes a silicone molding device 70, a silicone resin supply 80 and a control system 90. The apparatus 60 permits a three-dimensional silicone body to be molded onto an article of clothing including but not limited to a pair of jeans, a shirt, a hat, or a purse, in order to display a trademark, logo, advertising, etc. This further permits the creation of textured surfaces. More generally, as will be described below, the apparatus 60 permits a three-dimensional body of any thermosetting polymer to be molded onto substrates.

The silicone molding device 70 may comprise any number of conventional silicone molding devices, modified in accordance with the teachings of the present disclosure, adapted to mold three-dimensional bodies of silicone onto articles of clothing. More generally, the molding device 70 may comprise any number of conventional thermosetting polymer molding devices, modified in accordance with the teachings of the present disclosure, adapted to mold three-dimensional bodies of thermosetting polymer onto substrates.

The silicone resin supply system 80 may comprise any number of conventional silicone resin supplies, modified in accordance with the teachings of the present disclosure, and adapted to provide a controlled amount of silicone resin to the silicone molding device 70. The silicone resin supply system 80 provides a controlled supply of silicone resin, or other thermosetting polymer 21, to the silicone molding device 70 using a conventional supply conduit system 85. In a preferred embodiment, the silicone resin supply system 80 will comprise a plurality of silicone supplies to thereby permit the molding device 70 to simultaneously mold a plurality of silicone bodies of a plurality of colors onto an article of clothing. Examples of such silicones include at least the following: GE LIM 3745, GE LIM 6030, GE LIM 6045, GE LIM 6050 and GE LIM 6745, all may be commercially available from General Electric, Silicone Products Division, Waterford, N.Y.

Alternatively, and more generally, the silicone resin supply system 80 will instead provide a controlled amount of any number of commercially available thermosetting polymer resins including silicone, urethane, or nitrile rubber to the molding device 70.

Alternatively, and more generally, the silicone resin supply system 80 will comprise a plurality of resin supplies and will simultaneously provide a plurality of thermosetting polymer resins such as, for example, silicone, urethane or nitrile rubber to the molding device 70.

The control system 90 may comprise any number of conventional programmable and general-purpose computers or controllers, modified in accordance with the teachings of the present disclosure. The control system 90 communicates with, monitors and controls the operation of the silicone molding device 70 and the silicone resin supply system 80 using conventional communications busses 91 and 92 using conventional communication protocols.

Alternatively, the control system 90 may comprise hard-wired logic adapted to provide control of the various elements of the embodiments of the present disclosure. Alternatively, the control system 90 may comprise manual control by one or more operators of the embodiments of the present disclosure. Alternatively, the control system 90 may comprise any combination of programmable control, hard-wired logic, and manual operator control adapted to provide control of the various elements of the embodiments of the present disclosure.

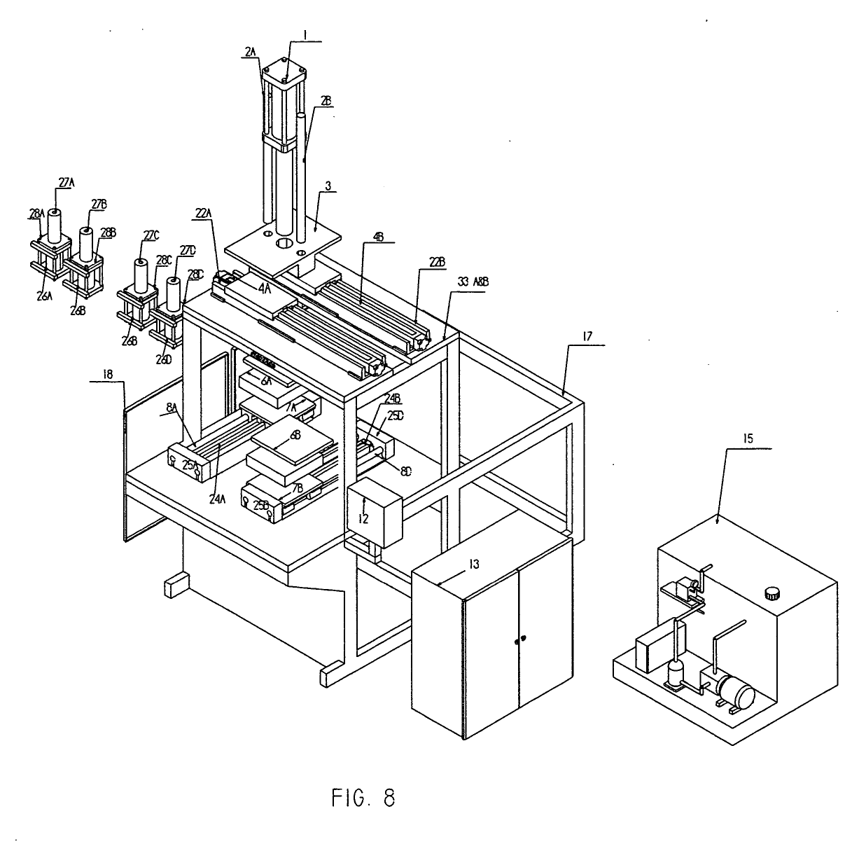

More generally, in a particularly preferred embodiment, referring now to FIG. 8, the apparatus 60 for molding three-dimensional bodies of silicone onto articles of clothing includes a plurality of molding devices or stations 70, a plurality of supplies of silicone resin supply system 80, and a control system 90. In this manner, the apparatus 60 is able to substantially simultaneously mold a plurality of three-dimensional bodies of silicone onto a plurality of articles of clothing. Furthermore, the plurality of supplies of silicone resin supply system 80 of the apparatus 60 permit a plurality of colors of silicone to be provided to each of the molding devices or stations 70. Consequently, a different mix of colors can be provided to each molding device or station 9 permitting a different pattern of three-dimensional silicone bodies to be molded onto articles of clothing at each molding device or station 9. Thus, the apparatus 60 provides a flexible and easily programmable and reconfigurable device for molding three-dimensional silicone bodies onto articles of clothing for use in displaying such material as trademarks, logos or advertising on articles of clothing such as shirts, pants, hats, purses, etc.

More generally, the apparatus 60 may be utilized to mold a plurality of three-dimensional bodies of any number of commercially available thermosetting polymers substantially simultaneously onto a plurality of substrates. More generally still, the apparatus 60 may be utilized to mold a plurality of three-dimensional bodies of a plurality of different types of thermosetting polymers substantially simultaneously onto a plurality of substrates.

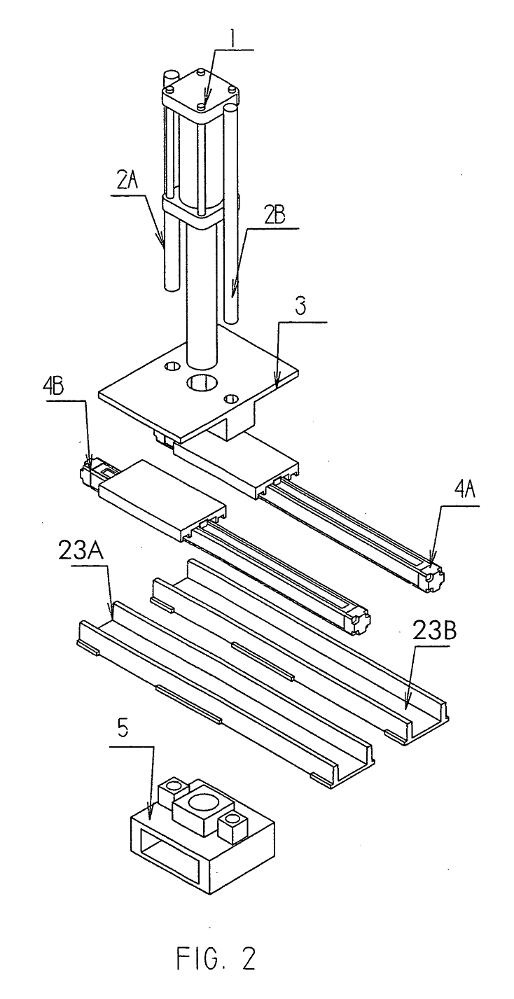

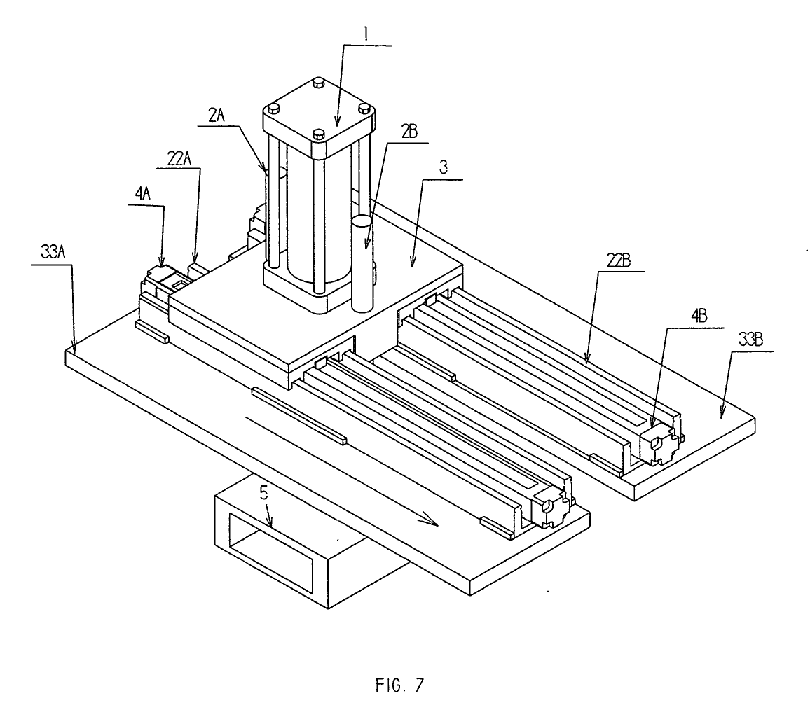

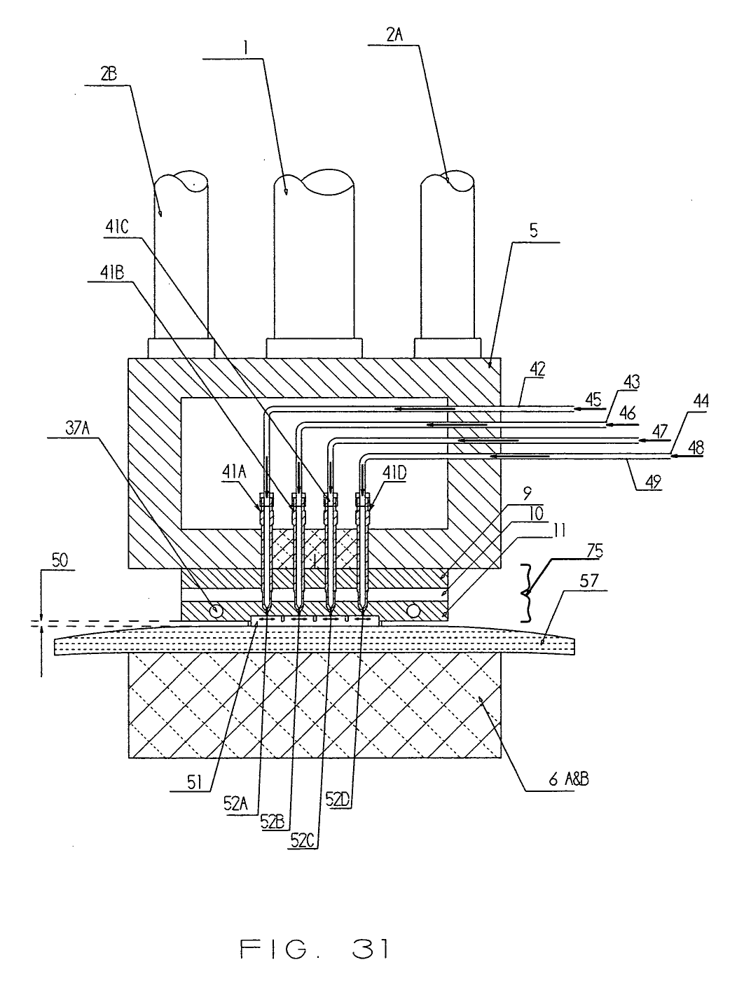

FIGS. 2 and 7 describe a preferred embodiment of a molding device 70. The molding device 70 includes a hydraulic actuator 1 where the power end is coupled to a die holder 5 for moving and positioning such die holder 5, two steel rods 2A and 2B for guiding and supporting the hydraulic actuator 1, which are mounted on a hydraulic actuator sliding fixture 3, and such hydraulic actuator sliding fixture 3 is coupled to two air cylinders 4A and 4B for moving the hydraulic actuator 1 horizontally to a predetermined position. Rails 23A and 23B are adapted to the air cylinders for support, alignment, and sliding surfaces for the hydraulic actuator sliding fixtures 3. The die holder 5 is adapted to hold a die set comprised of a receiving die member 9, a thermal isolation die member 10, and mold die member 11. Said die members are cooperatively coupled for a distribution of a chilled thermosetting polymer to flow under pressure to the heated section of the mold die member 11 and eventually injected on a substrate located opposite the opening of the mold die member 11. In operation, the molding device 70 molds at least one three-dimensional body of silicone onto a garment or article of clothing 57 of FIG. 31. Commercially available silicone materials may be obtained from General Electric, Silicone Products Division, Waterford, N.Y.

More generally, the molding device 70 may be used to mold at least one three-dimensional body of a thermosetting polymer including but not limited to silicone, urethane, or nitrile rubber onto a substrate including but not limited to cloth, paper, cardboard, wood, leather, wire mesh, sponge or foam rubber.

More generally still, the molding device 70 may be used to mold a plurality of three-dimensional bodies of a plurality of types of thermosetting polymers including but not limited to silicone, urethane or nitrile rubber onto a substrate including but not limited to cloth, paper, wood, leather, wire mesh, cardboard, sponge or foam rubber. One of the limiting factors is the curing profile of different materials, which may vary and prevent the use of diverse materials in the same operation under the same operating conditions.

The hydraulic actuator 1 controllably moves the die set 75 into and out of engagement with the garment 57 under the control of the control system 90. The hydraulic actuator 1 may be comprised of any number of conventional actuators including, but not limited to, pneumatic, hydraulic or electromechanical actuators. The movement of the hydraulic actuator 1 may be controlled using a combination of any number of conventional feedback control sensors and algorithms such as, for example, proportional-integral-differential. In a preferred embodiment, the actuator 1 is a hydraulic actuator, including pressure release and pressure sensors to stop at a predetermined position to prevent damage to the article of clothing 57 during engagement with the die set 75. In this manner, delicate articles of clothing 57 are not damaged during engagement with the die set 75. In a particularly preferred embodiment, the die set 75 is positioned within an air gap 50 from making contact with the article of clothing 57. Alternatively, and more generally, the preferred range of air gap will vary as a function of the hot gas created by the thermosetting polymers undergoing an increase in temperature as the chilled polymer is being exposed to the hot peripheral surfaces of the mold die member 11.

During exposure of the die set 75 with the article of clothing 57, the die set 75 receives at least one supply of silicone resin from the silicone resin supply system 80, injects at least one molding of silicone onto the article of clothing 57, thermally raises the temperature of the chilled thermosetting polymer on contact with the heated mold die member 11, and disengages from the article of clothing 57 under the predetermined settings of the control system 90. The die set 75 may be comprised of any number of conventional die sets for injecting molding of thermosetting polymers onto substrates, modified in accordance with the teachings of the present disclosure.

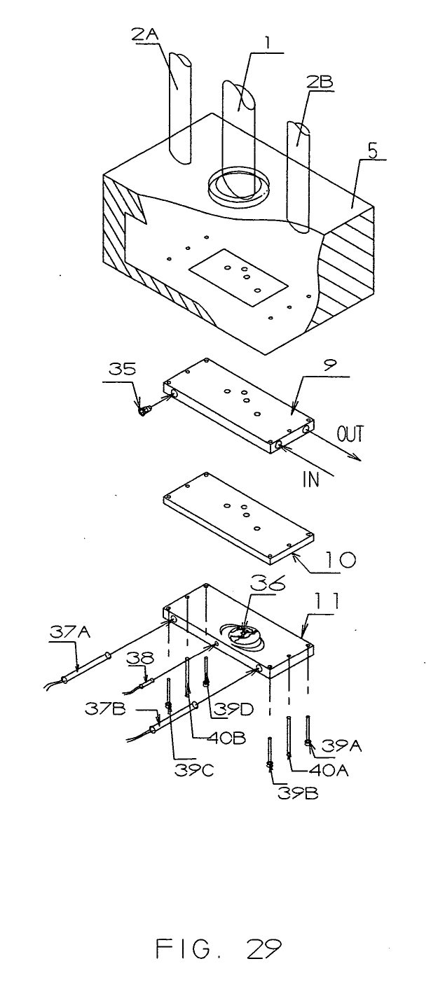

In a preferred embodiment, as illustrated in FIGS. 29, 30, 31 and 35, the die set 75 is engaged to inject a molding of a thermosetting with the article of clothing 90, the receiving die member 9 receives at least one supply of silicone resin from the silicone resin supply system 80 and transmits it to mold die member 11. The temperature of the receiving die member 9 is maintained to the same low temperature of the chilled thermosetting polymer. The thermal isolation die member 10 is intentionally coupled between the heated mold die member 11 and the chilled receiving die member 9 to prevent the heat in mold die member 11 from transferring to receiving die member 9 and to prevent premature curing of the thermosetting polymer. The die members 9, 10 and 11 of the die set 75 are coupled intimately by reasonably rigid pins 40A and 40B, and fasteners to maintain the alignment of the members respectively within the die set 75 in all aspects and to prevent the members from shifting relatively to one another as such shifting negatively affects the distribution and heats the thermosetting polymer. The mold die member 11 receives the distribution of at least one supply of chilled silicone resin, which is heated upon contact with the peripheral surfaces of the member 11, whereas the member 11 shapes the molding with at least one three-dimensional body of silicone, and injects onto the garment 57. Such silicone resins may be commercially available from General Electric, Silicone Products Division, Waterford, N.Y.

Alternatively, during engagement of the die set 75 with the article of clothing 57, the receiving die member 9 may receive at least one supply of a thermosetting polymer resin from the silicone resin supply system 80, and transmit it to the mold die member 11 for molding.

Alternatively, and more generally, during engagement of die set 75 with the article of clothing 57, the receiving die member 9 may receive supplies of a plurality of different types of thermosetting polymer resins such as silicone, urethane or nitrile rubber from the silicone resin supply system 80 and transmit it to the mold die member 11 for molding. In this manner, thermosetting polymers having similar time and temperature curing profiles may be simultaneously molded onto a substrate.

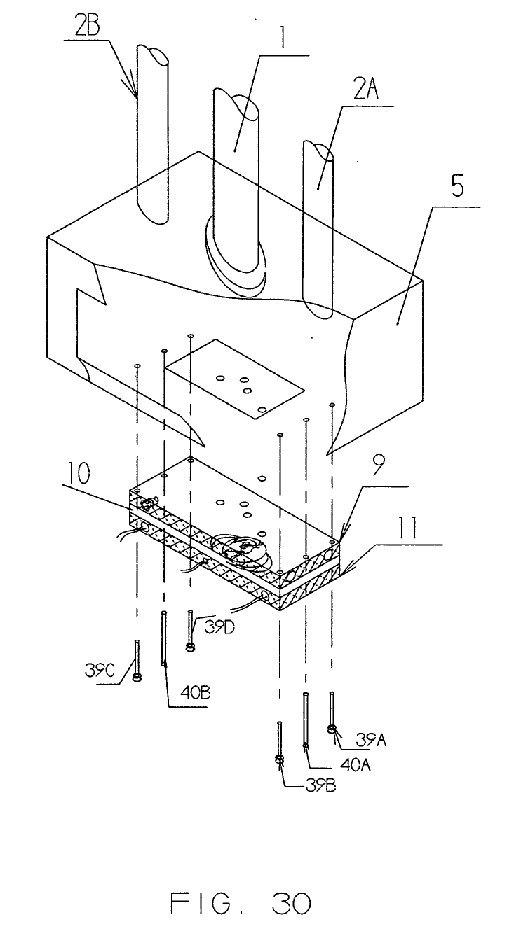

The guide members 40A and 40B and the fasteners 39A, 39B, 39C and 39D intimately couple rigidly the receiving die member 9, the thermal isolation member 10 and the mold die member 11 to the die holder 5. As illustrated in FIGS. 30 and 31, during engagement of the die set 75 with the garment 57, the members 90A and 90B guide the die set 75 in position and permit the die members 9, 10 and 11 to cooperatively interact thereby permitting the passage of silicone from the removable injection nozzles 41A, 41B, 41C and 41D to deliver the silicone 45, 46, 47 and 48 to the mold die member 11. This arrangement preserves the thermal integrity between the chilled silicone and the heated mold die member 11 and to prevent premature curing of the silicone prior to the desired delivery, namely the injection of the molding onto the substrate. The thermal isolation die member 10 thermally isolates the receiving die member 9 from the mold die member 11. In this manner, a single layer of a thermal isolation die member 10 is inserted between the receiving die member 9 and the mold die member 11 as disclosed to integrally minimize the heat transfer between all members of the die set 75 during operation of the molding device 70. In one of the preferred embodiments, a plurality of layers of such thermal isolation die members 10 may be used to enhance the integrity of the heat transfer. The control of the heat transfer is further enhanced by adaptively connecting a temperature sensor, namely a thermocouple 38, as shown by FIG. 29, to the mold die member 11 and connecting such thermocouple 38 to the PLC 13 to adjust and turn on and off the heat input to the mold die member 11 as required by the teachings of this disclosure. Furthermore, the chilled temperature of the silicone and any of the thermosetting polymers is maintained and controlled by the cooling element as shown by the input and output, which is adapted to the receiving die member 9.

Alternatively, an additional thermocouple 38 is adapted to the receiving die member 9 to determine the integrity of the heat transfer barrier and to prevent immature curing of the thermosetting polymer.

Furthermore, FIG. 31 illustrates an embodiment of the flow passages for the silicone distribution within the mold die member 11. The flow passages are formed in a single body using investment casting and CNC machining. Accordingly, the receiving die member 9 may receive at least one supply of a thermosetting polymer such as silicone, nitrile rubber or urethane by a transmission to the injection nozzle 41. The output end of the injection nozzle 41 is adaptively connected to the mold die member 11 and internally inserted through the receiving die member 9 and the thermal isolation die member 10. The input end of the injection nozzle 41 is connected to flexible supply line 42 of the silicone supply conduit system 85. Alternatively, the mold die member 11 may substantially simultaneously receive supplies of a plurality of different types of thermosetting polymers for injection by adapting a plurality of the injection nozzles 41A, 41B, 41C and 41D to the receiving die member 9 such as silicone, urethane or nitrile rubber. In this embodiment, thermosetting polymers having similar time and temperature curing profiles may be simultaneously molded onto substrates.

The silicone resin inlet passages are contained within the body of the mold die member 11. The silicone resin inlet passages are defined by injection nozzled tips 52A, 52B, 52C, and 52D positioned in one or more sides of the body of the mold die member 11 that extend sufficiently to raise the temperature of the thermosetting polymer by initial contact with the heated surface of the mold cavities 51. The silicone resin inlet passages are preferably positioned substantially normal to the direction of the silicone resin outlet passages. The cross-sectional shape of the silicone resin inlet passages is preferably substantially circular.

The cross-sectional areas of the silicone inlet passages may range, for example, from about 0.010 to 10 square inches for typical silicone materials to provide improved flow characteristics. In a preferred embodiment, the cross-sectional areas of the silicone resin inlet passages range from about 0.100 to 1 square inches in order to provide optimum flow characteristics for typical silicone materials. The preferred physical characteristics will differ depending upon the types of thermosetting polymers employed.

The silicone inlet passages and the silicone resin outlet passages may be formed in the mold die member 11 using any number of conventional fabrication processes. In a preferred embodiment, the silicone resin inlet passages and silicone resin outlet passages are formed by CNC machining.

The cooling element controllably maintains the operating temperature of the receiving die member 9 within a predetermined range of temperatures. In a preferred embodiment, for typical grades of silicone, the cooling element maintains the operating temperature of the receiving die member 9 between approximately 45° and 60° F. For typical grades of silicone resins, this preferred range of operating temperatures provides a silicone material having a paste-like quality that in turn minimizes unwanted flow and dripping of the silicone material within the die set 75. The preferred operating temperature ranges will differ depending upon the types of thermosetting polymers employed.

In a preferred embodiment, illustrated by FIG. 29, the cooling element is a fluid passage located within the body of the receiving die member 9 that conveys a cooling fluid such as chilled water through the body of the receiving die member to maintain the operating temperature of the thermosetting polymer at the desired range. In a preferred embodiment, the molding device 70 further includes a water cooling device, namely a chiller 14, which provides a controlled supply of water, or other cooling fluid, to flow through the cooling element. In the preferred embodiment, the output signal from temperature sensor 38, namely a thermocouple, is then utilized by the control system 90 to provide feedback control of the operating temperature of the receiving die member 9 and the mold die member 11 using a predetermined control algorithm.

The fluid passage of the cooling element may be formed on the body of the receiving die member 9 by brazing a thermally conductive fluid conduit onto a surface of the receiving die member 9. In the preferred embodiment, the fluid passage of the cooling element is formed in the body of the receiving die member 9 by machining channels of continuous passage to circulate the cooling fluid in and out of the receiving die member 9.

The cross-sectional areas of the silicone resin distribution passages may range, for example, from about 0.010 to 10 square inches for typical silicone materials to provide improved flow characteristics. In a preferred embodiment, the cross-sectional areas of the silicone resin inlet passages range from about 0.100 to 1 square inches in order to provide optimum flow characteristics for typical silicone materials. The preferred physical characteristics will differ depending upon the types of thermosetting polymers employed.

The silicone resin outlet passages are contained within the body of the mold die member 11. The silicone resin outlet passages are defined by openings positioned inwardly of the bottom face of the mold die member 11 and the shape of the openings must be sufficient to deliver the desired molding according to the disclosure.

The cross-sectional areas of the silicone resin outlet passages may range from about 0.010 to 10 square inches for typical silicone materials to provide improved flow characteristics. In a preferred embodiment, the cross-sectional areas of the silicone resin outlet passages range from about 0.100 to 1 square inches in order to provide optimum flow characteristics for typical silicone materials. The preferred physical characteristics will differ depending upon the types of thermosetting polymers employed.

In the preferred embodiment, that transmission of silicone resin from the silicone resin supply lines 42, 43, 44 and 49 to the corresponding silicone resin outlet passages of the mold die member 11 is facilitated by the injection nozzles 41A, 41B, 41C and 41D. As illustrated in FIG. 31, the injection nozzles 41A, 41B, 41C and 41D extend through the die holder 5 to the outlet passages of the die cavities 51 of the mold die member 5. In operation, during engagement of the die set 75 with the garment 57, the injection nozzles 41A, 41B, 41C and 41D cooperatively interact with complementary shaped silicone resin inlet passages in a top face of the mold die member 11. The silicone resin outlet passages may be formed, as integral parts of the mold die member 11, using conventional machining processes. In the preferred embodiment, the injection nozzles 41A, 41B, 41C and 41D and nozzle tips 52A, 52B, 52C and 52D are separable from die set 75 and comprised of a durable material such as tempered steel or stainless steel. In this arrangement, heat transfer from the mold die member 11, as the member is intimately coupled within the die set 75, is conservatively limited by positioning the isolation thermal member between such member and the receiving die member 9. Additionally, the nozzle tips 52A, 52B, 52C and 52D can be replaced without disturbing other members of the die set and effectively improve the efficiency of the operations with less downtime for repair or maintenance. Furthermore, the durable materials, namely machinable steel that can be shaped by machines, permit the use of higher pressure to deliver the injection of the thermosetting polymer for better efficiency than low strength material such as copper or ceramic.

In the preferred embodiment, as illustrated in FIG. 31, the mold die member 11 includes a plurality of injection nozzles 41A, 41B, 41C and 41D, a plurality of corresponding mold cavities 51A, 51B, 51C and 51D, heaters 37A and 37B, and a temperature sensor 38. The injection nozzles 41A, 41B, 41C and 41D of the mold die member 11 receive silicone resin from the corresponding silicone resin supply lines 42, 43, 44 and 49 of the silicone resin conduit system 85. The injection nozzles 41A, 41B, 41C and 41D transmit silicone resin to corresponding mold cavities 51A, 51B, 51C and 51D. The heaters 37A and 37B provide heat to cure the silicone resin bodies as they are formed by the mold cavities of the mold die member 11 and as they come into contact with the peripheral surfaces of the cavities 51A, 51B, 51C and 51D. The temperature sensor 38 permits feedback control of the operating temperature range of the mold die member 11. The injection nozzles 41A, 41B, 41C and 41D positions the tangential plane of the lower face of the nozzle tips 52A, 52B, 52C and 52D substantially coincident with the tangential plane of the upper inner surface of the mold cavities 51A, 51B, 51C and 51D of the mold die member 11. After the completion of the injection, the top surface of the molded three-dimensional body of silicone is substantially smooth.

In the preferred embodiment, the mold cavities 51A, 51B, 51C and 51D of the mold die member 11 are formed by first forming passages adapted to receive and intimately couple with the injection nozzles 41A, 41B, 41C and 41D, CNC machining the mold cavities 51A, 51B, 51C and 51D and then inserting the injection nozzles 41A, 41B, 41C and 41D. In this manner, the tangential planes of the upper inner surfaces of the mold cavities 51A, 51B, 51C and 51D are made substantially exactly coincident with the tangential lower planes of the lower faces of the nozzle tips 52A, 52B, 52C and 52D.

During operation of the molding device 70, the mold cavities 51A, 51B, 51C and 51D receive the silicone resin supply from the corresponding silicone injection nozzles 41A, 41B, 41C and 41D. The silicone resin fills the cavities 51A, 51B, 51C and 51D and forms the three-dimensional bodies of silicone resin on the top surface of the article of clothing 57. The heaters 37A and 37B raise the silicone resin bodies formed by the mold cavities 51A, 51B, 51C and 51D as the silicone comes into contact with the peripheral surface of the mold cavities 51A, 51B, 51C and 51D. Because of the pressure used in the injection, the heated silicone resin molding will create an adhesion to surface of the article of clothing 57 as it comes in contact with such surface and the adhesion is intensified as the molding solidifies.

The mold die member 11 may include any number of mold cavities 51 depending upon the intricacy of the particular graphical design to be affixed to the article of clothing 57. Furthermore, one or more of the silicone bodies formed may be comprised of different colors of silicone. The surface texture of the silicone bodies may be smooth or textured. The texture of the silicone body may be provided by a corresponding surface texture of the inner surface of the mold cavity 51.

The heaters 37A and 37B may comprise any number of conventional heating elements such as electrical heaters. In a preferred embodiment, the heaters 37A and 37B are bendable heating elements which are structurally cylindrical and commercially known as “cal rod”. A plurality of such cal rod heaters are used and are positioned substantially evenly between and among the mold cavities 51 of the mold die member 11 for an evenly distribution of thermal energy within the mold die member 11.

The temperature sensor 38 may comprise any number of conventional temperature sensors such as thermocouple or thermistor. In a preferred embodiment, the temperature sensor 38 is a thermocouple. The temperature sensor 38 generates a signal representative of an operating temperature of the mold die member 11 that is processed by the control system 90 to control the operation of the heaters 37A and 37B to maintain the operating temperature of the mold die member 11 within a predetermined range of temperatures. The predetermined range of the operating temperatures of the mold die member 11, for typical types and grades of silicone resin, may range from approximately 150° to 500° F.

The predetermined range of operating temperatures of the mold die member 11, for typical types and grades of silicone resins, ranges from about 150° to 300° F. The desired range of operating temperatures will differ depending upon the types of thermosetting polymers employed.

In an alternative preferred embodiment of the mold die member 11, raised borders are provided about a periphery of each of the mold cavities 51A, 51B, 51C and 51D that extend outward from the bottom surface of the mold die member 11. The raised borders minimize splattering of the hot silicone molding and define in part the shape of the graphic, thereby optimizing the injection of the silicone molding to the article of clothing 57. The thickness and height of the raised borders may range from about 0.25 to 1.5 millimeters 0.02 to 9 millimeters respectively. The preferred thickness and height of the raised borders range from about 0.50 to 0.75 millimeters and 0.50 to 6 millimeters respectively. The preferred range of the thickness and height of the raised borders will vary as a function of the size and configuration of the mold cavities 51A, 51B, 51C and 51D and the type of thermosetting polymers.

The mold die member 11 includes a plurality of flow passages and heaters 37A and 37B. The flow passages are continuously coupled and they extend from the inlet passages at the nozzle tips 52A, 52B, 52C and 52D of the injection nozzles 41A, 41B, 41C and 41D to the cavities 51 of the mold die member 11. The adaptation of the injection nozzles 41A, 41B, 41C and 41D to the flow passages for conveying silicone resin from the silicone resin supply lines 42, 43, 44 and 49 to the mold die member 11 facilitates the conservation of the heat transfer integrity between the chilled section and the heated section of the die set 75 and minimizes the premature exposure of the thermosetting polymer. The heaters 37A and 37B provide thermal energy and may comprise any number of conventional heating elements such as electrical heaters or cal rods. In a particularly preferred embodiment, the heaters 37A and 37B are distributed among and between the flow passages in order to provide a substantially even distribution of thermal energy. The operating temperature of the mold die member 11 is preferably controlled by the control system 90, which monitors the temperature of the mold using the temperature sensor 38. The control system 90 then preferably controls the operation of the heaters 37A and 37B to maintain the operating temperature of the mold die member 11 within a predetermined range of temperatures.

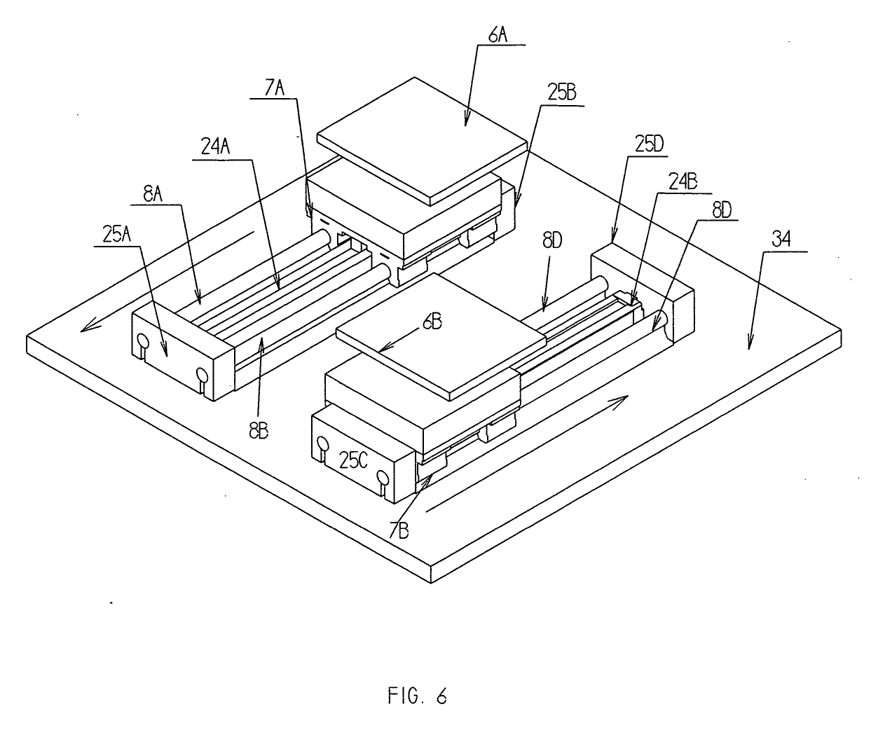

In a preferred embodiment, as illustrated in FIGS. 6, 33 and 34, the back plate 6A or 6B includes a back plate body adaptively mounted on a sliding fixture 7A or 7B, sliding track members 8A, 8B, 8C and 8D, air cylinders 24A and 24B, sliding blocks 25A, 25B, 25C and 25D, and a supporting member 34. The back plate 6A or 6B supports and positions the article of clothing 57, or other substrate, during engagement with the die set 75 of the molding device 70. In particular, during engagement of the die set 75 with the top surface of the article of clothing 57, the die set 75 is positioned as such the bottom surface of the mold die member 11 and the top surface of the article of clothing 57 is separated by an air gap sufficient to permit the hot gas from the formation of the thermosetting polymer molding.

The back plate 6A or 6B is preferably a substantially planar upper surface that directly supports the article of clothing 57. The back plate 6A or 6B preferably includes at least one redundant controlling member, namely sliding blocks 25A, 25B, 25C and 25D, and controllable moving device such as air cylinders 24A and 24B to properly move and position the article of clothing 57 in coordination and relative to the die set 75.

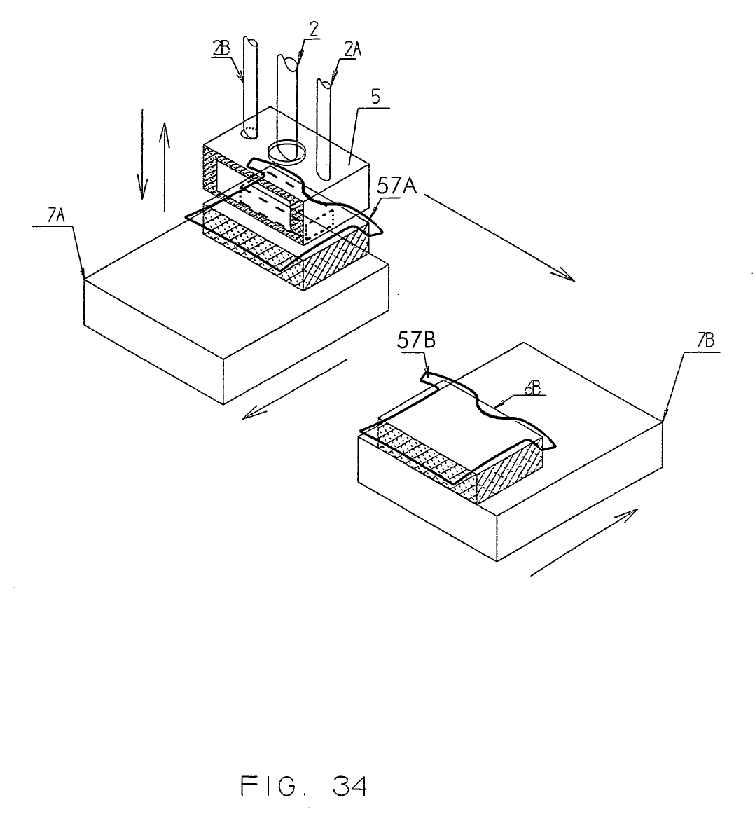

In one of the embodiments, illustrated in FIG. 34, the back plate 6A or 6B is designed to support and position a T-shirt 57. The T-shirt 57 fits over the back plate 6A or 6B with a part of the surface of the back plates 6A and 6B is used to provide reference surfaces to provide proper positioning of the T-shirt 57 relative to the die set 75. For different types of substrates, different reference surfaces will be provided.

As illustrated in drawings FIGS. 6 and 34, the back plate 6A or 6B is moved into and out of position below and opposite to the die set 75 by the power of the air cylinders 24A and 24B which are programmably controlled by the PLC 13. The back plate 6A or 6B operates in coordination and sequentially with the die set 75 by a predetermined algorithm, which is programmed in the PLC 13. The PLC 13 controls and coordinates the motion of the hydraulic actuator 1 to safely position the die set 75 and activate the injection to form the graphic design onto the substrate. The hydraulic actuator 1 lowers the die set 75 as the back plate 6A or 6B with the loaded substrate 57 move into position opposite of the die set 75 to begin the injection of the thermosetting polymer. The hydraulic actuator 1 is set by the algorithm to stop within the air gap without the bottom surface of the mold die member 11 touching the top surface of the substrate 57. The hydraulic actuator 1 retracts the die set 75 after the injection is complete. The dies set 75 is conjunctively connected to the hydraulic actuator 1 by connecting the top of the die set 75, namely the top of the receiving die member 9, to the bottom end of the die holder 5 and connecting the power shaft of the hydraulic actuator 1 to the top end of the die holder 5. In this manner, loading and unloading of substrates 57 onto and off of the platen are facilitated by permitting the operator to operate outside of the strike zone of the die set 75. This preferred embodiment provides added safety by eliminating the possibility of injury to the operator caused by mistakenly engaging the die set 75 while loading and unloading of substrates 57 onto and off of the back plate 6A or 6B.

The support member 34 supports the dynamic loads and the static load of the assembly of the back plates 6A and 6B and during the injection of the thermosetting polymer. The support member 34 may comprise any number of structural support members capable of maintaining the structural integrity and reasonably rigid support during the molding process. Transition members support the back plates 6A and 6B and cooperatively connect the back plates 6A and 6B to the sliding fixtures 7A and 7B. This arrangement permits the back plates 6A and 6B to be controllably moved by the air cylinders 24A and 24B and guided by the sliding track members 8A, 8B, 8C and 8D. The sliding track members 8A, 8B, 8C and 8D may comprise any number of conventional rolling members capable of rigid support during the molding process. The sliding track members 8A, 8B, 8C and 8D provide directional guidance to the back plates 6A and 6B during the loading and unloading process. The sliding track members 8A, 8B, 8C and 8D also facilitate the positioning of the back plates 6A and 6B below and opposite the die set 75. In the preferred embodiment, the sliding track members 8A, 8B, 8C and 8D include sliding blocks 25A, 25B, 25C and 25D that provide set points related to the air cylinders for controlling the travel and positions of the back plates 6A and 6B below and opposite the die set 75.

Referring to drawing FIGS. 31, 33 and 34, during engagement of the die set 75 with the article of clothing 57, the hydraulic actuator 1 moves the die set 75 toward the top surface of the article of clothing 57 that is supported and positioned by the back plate 6A or 6B. The hydraulic actuator 1 continues to move the die set 75 until the die set 75 fully stops within the predetermined air gap of the top surface of the article of clothing 57.

The movement of the die set 75 into engagement with the top surface of the article of clothing 57 by the hydraulic actuator 1 is controlled by the control system 90 using any number of conventional control algorithms and subjected to any number of conventional position sensors. Alternatively, the movement of the die set 75 into engagement is controlled by the control system 90 using position sensors, pressure sensors, speed sensors, position and pressure sensors, position and speed sensors, pressure and speed sensors, or position, pressure and speed sensors. Furthermore, the movement of the die set 75 into engagement with the top surface of the article of clothing 57 is controlled by the control system 90 by monitoring at least a pressure sensor that generates a signal representative of a contact pressure of the die set 75 with a reference surface representing the predetermined air gap 50 formed by the bottom surface of the mold die member 11 and the opposite surface of the article of clothing 57. In this manner, the article of clothing 57 will not be damaged by the die set 75 during engagement. The preferred air will differ depending upon the types of substrates and thermosetting polymers employed.

Upon engaging the die set 75 within the predetermined air gap at the top surface of the article of clothing 57, the silicone resin supply system 80 injects a controlled predetermined amount of silicone resin into each of the mold cavities 51 of the heated mold die member 11. The controlled amount of silicone resin is received by the injection nozzle 41 mounted intimately to the cooled receiving die member 9 and passes through the thermal isolation die member 10 to the corresponding injection nozzle tip 52. The injection nozzle tip 52 distributes the silicone resin to the corresponding mold cavities 51 of the heated mold die member 11. The silicone resin then fills the corresponding mold cavities 51 of the mold die member 11 to form at least one three-dimensional body of silicone resin on the article of clothing 57.

More generally, upon full engagement of the die set within the predetermined air gap at the top surface of the article of clothing 57, the silicone resin supply system 80 injects a controlled predetermined amount of a plurality of different types of thermosetting polymer resins into the mold cavities 51 of the heated mold die member 11. The controlled amounts of the different types of thermosetting polymer resins are received by the injection nozzles, which are intimately mounted to the receiving die member 9, and internally connected through the thermal isolation die member 10 to the heated mold die member 11. The nozzle injection tip 52A, 52B, 52C and 52D distributes the thermosetting polymer resins via the distribution channels to the corresponding mold cavities 51 of the heated mold die member 11. The thermosetting polymer resins then fill the corresponding mold cavities 51 of the mold die member 11 to form a plurality of three-dimensional bodies of a plurality of types of thermosetting polymer resins on the substrate 57. In this manner, thermosetting polymers having similar time and temperature curing profiles may be simultaneously molded onto substrates.

For typical types and grades of silicone, the operating temperature of the cooled receiving die member 9 may range from about 50° to 65° F. In a preferred embodiment, the operating temperature of the receiving die member 9 is maintained from about 55° to 60° F. Alternatively, for different thermosetting polymers, the preferred operating temperatures may differ.

The volumetric flow rate and pressure of the injection of silicone resin into the mold cavities 51 of the heated mold die member 11 is preferably controlled to effectively produce the desired graphic design on the substrate 57. For typical clothing materials and grades of silicone resin, the volumetric flow rate and pressure of the silicone resin injection may range from about 0.33 to 0.50 in³/sec and about 200 to 800 psig. In a preferred embodiment, for typical clothing materials and grades of silicone resin, the volumetric flow rate and pressure of the silicone injection ranges from about 0.01 to 0.33 in³/sec and about 300 to 600 psig. Alternatively, the preferred flow rates and pressures will differ depending upon the specific types of substrates and thermosetting polymer resins employed.

The silicone resin initially will adhere to the top surface of the material of the article of clothing 57 and solidified as it cures. The three-dimensional body of silicone resin is cured by action of the heat transferred from the heated mold die member 11 as the silicone resin contacts the peripheral surfaces of the mold die member 11. The amount of time required to cure the three-dimensional bodies of silicone resin depends upon the volume of the three-dimensional bodies of silicone resin and the material type in a well known manner. Alternatively, the curing time is incorporated into computing the time the die set 75 engages the substrate 57.

Generally, the operating temperatures of the mold die member 11 may range from about 75° to 500° F. In a preferred embodiment, for typical types and grades of silicone, the operating temperatures of the mold die member 11 range from about 150° to 300° F. Alternatively, for different thermosetting polymers, the preferred operating temperatures will differ. The type of silicone used in the molding device 70 may comprise any number of commercially available silicone products such as GE LIM 3745, GE LIM 6030, GE LIM 6090, GE LIM 6045, GE LIM 6050 or GE LIM 6745, which may be commercially available from the General Electric Company, Silicone Products Division in Waterford, N.Y.

Any thermosetting polymer may be used in the molding device 70 to form three-dimensional bodies of a thermosetting polymer on a substrate. Such thermosetting polymers include at least the following: silicone, nitrile rubber or urethane, and such substrates include at least the following: cloth, paper, cardboard, wood, leather, wire mesh, sponge, or foam rubber.

Once the three-dimensional bodies of silicone are delivered by injection on the positioned article of clothing 57, the die set 75 is disengaged. Upon disengagement, the mold die member 11 retracts as the hydraulic actuator 1 moves vertically upward and the backplate 6A or 6B slides away to deposit the substrate 57 outside the strike zone of the molding device 70. The thermal isolation die member 10 provides a thermal barrier to prevent silicone resin from curing within the injection nozzles 52A, 52B, 52C and 52D.

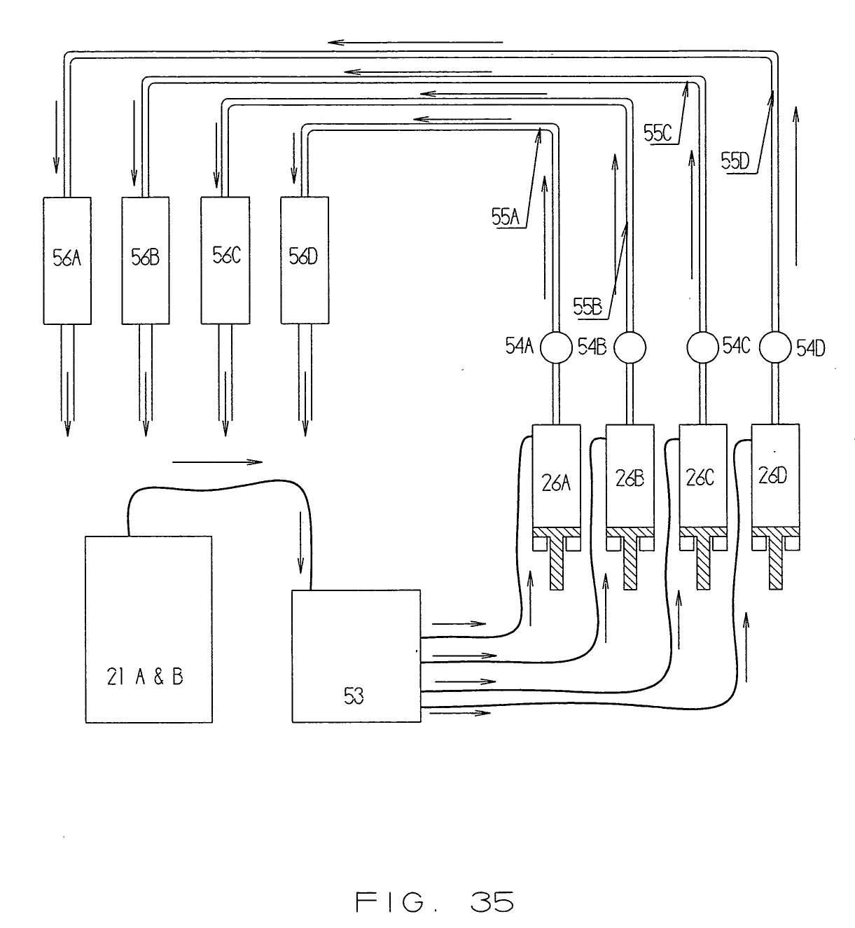

Accordingly, drawing FIG. 35 illustrates the preferred embodiment with one or more flow control valves 54A, 54B, 54C, 54D or 54E for controllably connecting the silicone resin flow passages, namely injection nozzles 41A, 41B, 41C or 41D to a silicone resin supply 21A and 21B, and a color mixer, 53. Under this arrangement, the injection of silicone resin into the die set 75 may be precisely controlled and stopped by action of the flow control valve 54. This in turn will allow the injection system to build up a predetermined pressure suitable to deliver a predetermined silicone shot to the die set 75. The flow control valve 54A, 54B, 54C, 54D, 54E or all the control valves include actuators which are connected to the PLC 13, are controllably operated in coordination with the predetermined and programmable injection process algorithms.

Alternatively, the injection of a thermosetting polymer resin into the die set 75 may be precisely controlled and stopped by action of the flow control valve 54, which is adapted to control the pressure and flow rate of the material. This in turn will allow the injection system to build up a predetermined pressure suitable to deliver a predetermined silicone shot to the die set 75. The flow control valve 54B, 54C, 54D, 54E or all the control valves include actuators, which are connected to the PLC 13, are controllably operated in coordination with a predetermined and programmable injection process algorithms.

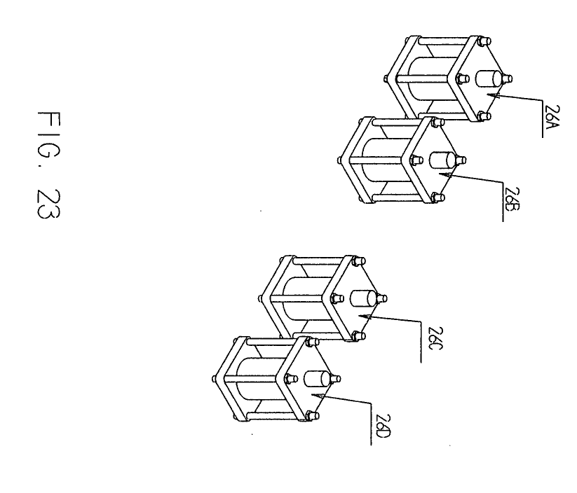

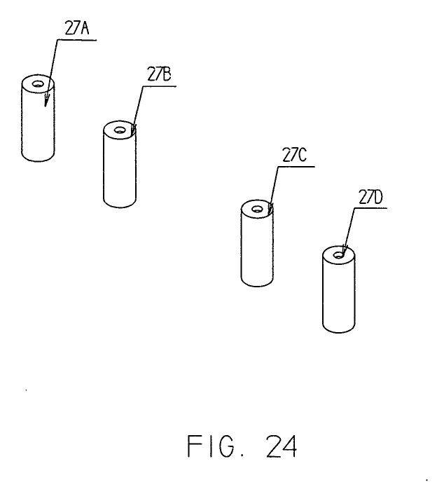

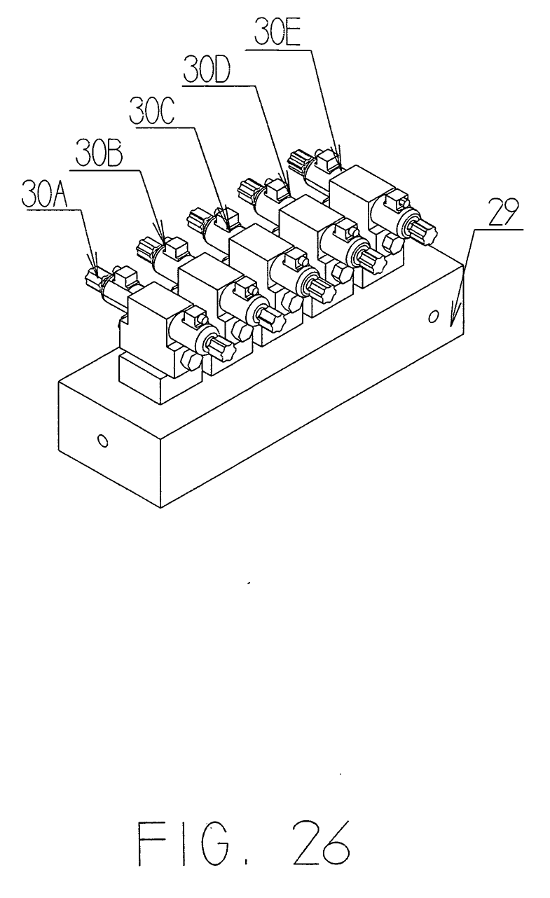

Furthermore, in the preferred embodiment, as illustrated in drawing FIGS. 1, 23, 24, 26 and 35, the hydraulic activated injection valve 30A, 30B, 30C, 30D, or 30E comprise a two-position valve, including a two-position valve element and an actuator, mounted within the body of the manifold 29 and controlled by the control system 90 and specifically by the PLC 13. In a first position, the two-position injection valve 30 permits flow of silicone resin from a silicone resin supply system 80 to a corresponding one of the silicone injection pumps 26A, 26B, 26C, 26D or 26E by drawing the corresponding piston below the inlet of the injection cylinder of the injection pump 26A, 26B, 26C, or 26D. In a second position, the two position injection valve 30 forces the silicone resin to flow out of the cylinder by applying a hydraulic flow to pressurize the injection piston 27A, 27B, 27C, 27D or 27E and force the piston 27A, 27B, 27C, 27D or 27E to move forward. The forward motion sequentially force the silicon shot through the opening of the control valve 54A, 54B, 54C, 54D or 54E, which was previously closed. The silicone shot follows the injection lines 55A, 55B, 55C, 55D or 55E to an adaptable connector 56A, 56B, 56C, 56D or 56E connected to the corresponding injection nozzle 41A, 41B, 41C or 41D, and to the injection nozzle tip 52A, 52B, 52C or 52D accordingly connected to the distribution channels of the mold die cavity 51. The size and the physical aspects of the silicone shot determines the draw of the piston 27A, 27B, 27C, 27D or 27E. Furthermore, the larger the volumetric size of the silicone shot the longer is the draw of the piston 27A, 27B, 27C, 27D or 27E if the diametrical cross section of the piston is fixed, a variation in the volume of the shot requires the draw of the piston to vary accordingly. The silicone pumps 22A and 22B provides a necessary hydraulic lift to deliver the silicone resin to the injection cylinder of the injection pump 26A, 26B, 26C or 26D. The cross-sectional areas of the various flow passages of the systemic elements of the silicone resin supply, namely the control valves, the injection pumps are preferably selected to prevent turbulent flow of the silicone resin, or the particular thermosetting polymer resin, in operation. Alternatively, the number of control valves, conduits, nozzles, nozzle tips and injection pumps varied according to the number of silicon resins necessary to produce a graphic design. The use of injection pumps 26A, 26B, 26C, 26D and 26E allows the silicone shot to be delivered precisely for the predetermined amount without the silicone drip generally associated with other arrangements because the inherent accuracy of the metering mechanism of the injection pumps 26A, 26B, 26C, 26D and 26E is well known and can be used to eliminate excess silicone material. This arrangement eliminates the need to use exhaust pump, vacuum source such as evacuated chamber, air blast to remove excess silicone from the die set 75 or the flow passage to the die set 75.

The preferred embodiment includes a plurality of silicone resin supplies 21A and 21B or more. The plurality of silicone resin supplies 21A and 21B are preferably controllable to provide a predetermined amount a plurality of supplies of silicone resin to each of the molding devices 70. In this manner, each of the molding devices 70 can mold a plurality of diverse types of thermosetting polymers and three-dimensional bodies onto substrates substantially simultaneously. Furthermore, the plurality of supplies of silicone resin supply system 80 is preferably provided with at least a plurality of colors of silicone resin. A color mixer 53 is used to provide a predetermined color to the predetermined polymer thermosetting by adding a color pigment to the thermosetting polymer from the silicone resin supplies 21A and 21B. The representation of the silicone resin supplies 21A and 21B is illustrative for materials A and B and not limiting. Alternatively, the number of resin supplies 21 can be A, B, C, D, E and etc. The plurality of the injection nozzles 41A, 41B, 41C and 41D, the injection pumps 26A, 26B, 26C, 26D and 26E, the control valves 54A, 54B, 54C, 54D and 54E, the conduit lines 55A, 55B, 55C, 55D and 55E, and the injection adapters 56A, 56B, 56C, 56D and 56E is thereby a representation of deliverable means of thermosetting polymer. A silicone conduit manifold 19 collects the plurality of thermosetting polymers from the silicone resin supplies 21A and 21B to a common distribution channel adapted to receive and distribute individually the thermosetting polymers the color mixer 53 thereby feeds the plurality of injection pumps 26A, 26B, 26C, 26D and 26E a predetermined shot. The silicone conduit manifold 19 includes at least one inlet and one outlet. The volumetric size of the silicone conduit manifold 19 may range, for example, from about 0.125 to 100 gallons. In a preferred embodiment, for typical types and grades of silicone, the volumetric size of the silicone conduit manifold 19 is about 10 gallons. Alternatively, more generally, the desired volumetric size of the silicone conduit manifold 19 will vary as a function of the particular thermosetting polymer selected as well as the size and number of molding devices 70 and mold cavities 51 simultaneously in use. In an alternative preferred embodiment, the color pigment is omitted to be included in the silicone conduit manifold 19 and only uncolored polymer resin is produced. Consequently, the number of various colors and types of thermosetting polymers are represented the same. In this manner, each molding device can mold a plurality of three-dimensional silicone bodies having a plurality of colors onto a substrate. Alternatively, the silicone conduit manifold 19 may be adapted to mix and color any number of thermosetting polymer resins such as silicone, nitrile rubber or urethane.

Alternatively, and more generally, a plurality of thermosetting polymer supply systems 80 preferably controllably provide a predetermined amount a plurality of supplies of thermosetting polymer resins to each of the molding devices 70. In this manner, each of the molding devices 70 can mold a plurality of three-dimensional bodies of thermosetting polymers onto substrates substantially simultaneously. Furthermore, the plurality of supplies of thermosetting polymer resins preferably provide at least a plurality of colors of thermosetting polymer resins. In this manner, each molding device can mold a plurality of three-dimensional thermosetting polymer bodies having a plurality of colors onto a substrate.

The materials A and B may comprise any number of conventional constituent materials for conventional silicones such as GE LIM 3745, GE LIM 6030, GE LIM 6045, GE LIM 6050 and GE LIM 6745 may be commercially available from General Electric, Silicone Products Division, in Waterford, N.Y. In a preferred embodiment, the materials A and B comprise conventional constituent materials for silicones identified as GE LIM 3745 and GE LIM 6745, available from General Electric, Silicone Products Division, in Waterford, N.Y. More generally, any thermosetting polymer resin that requires the mixture of two or more materials may be utilized by the appropriate addition, as necessary, of additional supplies, pumps, flow control assemblies and distribution chambers. In this manner, the plurality of silicone resin supply system 80 may be adapted for use with virtually any thermosetting polymer. Examples of such thermosetting polymers include at least silicone, nitrile rubber or urethane.

The pumps 22A and 22B may comprise any number of conventional hydraulic pumps capable of pumping typical types and grades of silicone resin constituent materials. Furthermore, the pumps 22A and 22B may comprise constant or variable displacement pumps. The pumps 22A and 22B may pump materials A and B at flow rates ranging from about 0.1 gpm to 100 gpm In a preferred embodiment, the pumps 22A and 22B pump the materials A and B at flow rates ranging from about 1.0 to 10.0 gpm. Alternatively, more generally, the desired flow rates will vary as a function of particular thermosetting polymer selected and the constituent materials comprising the specific thermosetting polymer selected.

The flow control assemblies of pumps 22A and 22B control the operating pressure and flow rate of materials A and B, and each include an accumulator, a pressure sensor, a flowmeter, a variable orifice, a pressure relief valve and a drainage valve, which are provided conventionally by a pump manufacturer.

In operation, the accumulator receives material pumped into the flow control assembly. The accumulator operates in a well-known manner to maintain a controlled reservoir of material at a predetermined range of operating pressures. The operating pressure of the material is monitored by the pressure sensor, which generates, in a well-known manner, a signal representative of an operating pressure of the material within the flow control assembly for processing by the control system 90. The flowmeter monitors the flow rate of material within the flow control assembly and generates, in a well-known manner, a signal representative of a flow rate of the material for processing by the control system 90. The variable orifice controls the flow rate of material exhausting from the flow control assembly under the control of the control system 90. The pressure relief valve automatically releases material from the flow control assembly whenever the operating pressure exceeds a predetermined maximum as determined by a spring bias provided in the pressure relief valve. The exhaust valve controllably permits material to be exhausted from the flow control assembly under the control of the control system 90. The control system 90 monitors the pressure sensor and flow sensor, and controllably operates the variable orifice and exhaust valve to maintain the operating pressure and flow rate of the flow control assembly within a predetermined range of values using conventional control algorithms for fluids.

For typical silicone constituent materials, the flow control valve assemblies and related flow components including silicone conduits and injection pumps are selected to maintain the integrity for an operating pressure between about 10 and 1000 psig. In a preferred embodiment, for typical silicone constituent materials, the flow control assemblies maintain the operating pressure between about 100 and 800 psig. For typical silicone constituent materials, the flow control assembly is selected to maintain the flow rate of the materials within the flow control assemblies between about 0.1 gpm to 100 gpm during an injection cycle. In a preferred embodiment, for typical silicone constituent materials, the flow control assemblies maintain the flow rate of the materials within the flow control assemblies between about 1 and 10 gpm during an injection cycle. Alternatively, the desired operating parameters of the flow control assemblies will depend upon the particular thermosetting polymer selected and the specific constituent components of that thermosetting polymer. The control system 90 monitors and controls the operation of the apparatus 60 and includes at least one more sensors and actuating devices. As illustrated in drawing FIGS. 1 and 8, in a preferred embodiment, the control system 90 includes a programmable general purpose computer or programmable PLC 13, a keyboard, a touch screen monitor 12, a modem, a local-area-network communication device, a wide-area-network communication device, the silicone resin pumps 22A and 22B, the water cooling devices (chiller) 14, the molding device 70, the heaters 37A and 37B, the hydraulic actuated injection valves, including at least 30A, 30B, 30C, 30D and 30E, the silicone resin supply system 80, the pressure sensors for the silicone resin supply system 80, the temperature sensors, including at least one thermocouple 38, the hydraulic actuator 1 for the molding device 70, the flow sensors for the silicone resin supply system 80, control switches 16A and 16B for the apparatus 60, and redundant safety switches with laser connection for the apparatus 60.

The PLC 13 monitors and controls the operation of the apparatus 60. The PLC 13 may comprise any number of conventional programmable industrial controllers capable of transmitting and receiving analog and digital signals. The PLC 13 may communicate with the various input-output devices of the apparatus 60 using any number of conventional communication protocols.

The PLC 13 preferably includes a conventional operator interface such as a touch screen monitor 12.

The PLC 13 preferably includes a network card that permits communication between the PLC 13 and other remote devices. The network card may comprise any number of conventional network card.

The control system 90 preferably includes a Local Area Network (LAN) to enable communication with a number of remote devices in a conventional network environment. With this arrangement, a number of apparatus 60, which are situated at diverse geographic locations as they are remotely controlled and monitored using the LAN comprising any number of conventional devices and communication protocols, may be used to inject graphic design onto garments or other substrates.

Additionally, the control system 90 preferably includes a number of conventional operator safety devices including control switches 16A and 16B, which are redundantly interactively connected to light curtains, namely a number of cut-off switches using laser light as a connecting bridge. A break in the continuity of the laser light path will consequently discontinue the electrical flow as well as cutting off the supplying power to the molding device 70. The control switches 16A and 16B are of conventional design and operation and protect the operator from physical injury by requiring the operator to press both switches during engagement of the die sets 75 of the molding devices 70. The light curtains are of conventional design and construction and surround the molding devices 70 with a light barrier that, if broken, shuts down the molding devices 70 to protect the operator from injury.

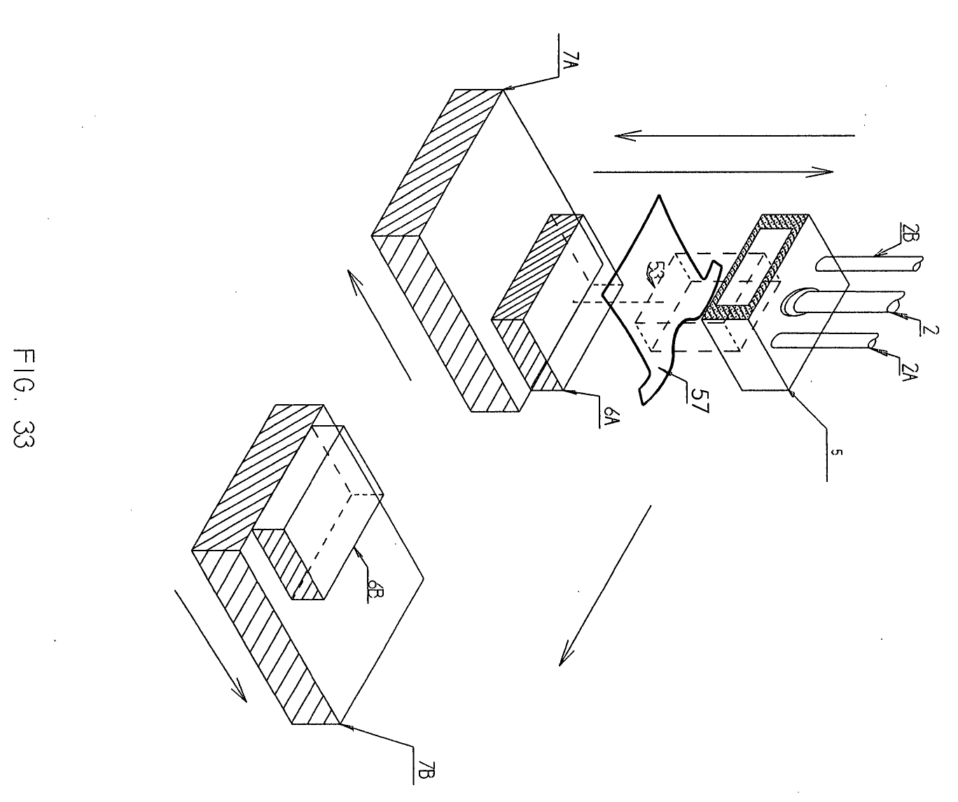

Drawing FIGS. 33-34 illustrate a preferred embodiment of the operation of the molding device 70, namely an injection cycle. At an initial startup, a physical set-up of the molding device 70 is required. Generally, the set-up includes preparing and determining the pressure for the hydraulic actuator 1 for the molding device 75, selecting, assembling and aligning the die set 75 for the molding device 70, selecting and determining the proper silicone resin, or other thermosetting polymer resin, supplies 21 for the molding device 70 and the commercial order, and loading computer coded instructions and initializing the control system 90.

After the initial sequence of the startup has been started, the following sequence will initiate cooling for all related fluidic containment system for the delivery of the silicon prior to contact with the heated mold die member 11. The cooling sequence will preferably include the steps of selecting a predetermined range of operating temperatures, starting the chiller 14, receiving the signal output from the thermal sensors, which strategically are located at the receiving die member 9, the silicone conduit manifold 19 and the die holder 5, and maintaining the predetermined temperature. For typical types and grades of silicone resins, the operating temperatures range from about 50° to 65° F. In a preferred embodiment, the operating temperature ranges from about 55° to 60° F. The preferred operating temperature range will vary as a function of the volume and particular type and grade of thermosetting polymer selected for use with the molding device 70.

In the continuity of the start-up sequence, the PLC 13 continues to initiate heating for the mold die member 11. The heating sequence will preferably include the steps of selecting a predetermined range of operating temperatures for the mold die member 11, closing the heating circuit switches to allow the heaters 37A and 37B to generate heat, receiving output signal from the temperature sensor 38, and maintaining the predetermined temperature. For typical types and grades of silicone resins, the operating temperature ranges from about 75° to 500° F. In a preferred embodiment, the operating temperature ranges from about 150° to 300° F. The preferred operating temperature range of the mold die member 11 will vary as a function of the number and volume of mold cavities 51, and the particular type and grade of thermosetting polymer resin selected for use with the molding device 70.

The order of execution of the start-up sequences to initiate the cooling and heating operations are simultaneous and alternatively it can be consecutively performed through the commands of the PLC 13 depending on the available power capacity and environmental circumstances. Considerations are given to prevent the operating temperature of the receiving die member 9 from fluctuation due to rising heat transfer from the mold die member 11, which is conventionally known during start-up. These cooling and heating sequences do not affect the back plates 6A and 6B, which do not have a dedicated cooling and heating system as used in conventional devices.

Including in the operational steps are the system pressure checks for the air cylinders 4A, 4B, 24A and 24B, and the hydraulic activated injection valves 30A, 30B, 30C, 30D and 30E.

The cooling effect of the back plates 6A and 6B is by natural convection and conduction, which occur continuously during and at the end of the delivery of the graphic design after the heated mold die member retracted away of the substrate. The heating of the back plate 6A and 6B occurs as a residual of the heat transfer from the hot thermosetting polymers being injected onto the substrate. The contact pressure of the die set 75, as it contacts a pressure sensor as the die set 75 moves down during to start the injection cycle of thermosetting polymers onto substrates, is predetermined accordingly to set the appropriate air gap sufficient to evacuate the gas forming during the heating of the thermosetting polymer. The selection of contact pressure of the die set 75 will preferably include the steps of selecting a predetermined range of appropriate contact pressures of the die set 75. For typical types and grades of thermosetting polymers, the contact pressure of the die set 75 during injection may range from about 50 to 600 psig. The preferred range of contact pressure between the die set 75 and the pressure sensor during injection varies as a function of the types and grades of the thermosetting polymers.

The selection of the contact pressure is predetermined and entered in the programmable functions of the PLC 13. As part of the system control, the PLC 13 will receive a database for predetermined quantity of silicone resin, or other thermosetting polymer resin and also known as a silicone shot, which will be selected for injection into each of the mold cavities 51 of the mold die member 11. The selection of the quantity of silicone resin for injection into each of the mold cavities 51 of the mold die member 11 will preferably include a selection of a separate quantity for each mold cavity 51 of the mold die member 11. Using this application, a plurality of supplies of silicone resin may be controllably and diversely, in quantity, injected into the mold cavities 51 of the mold die member 11 from a plurality of supplies of silicone resin 21. Typically, the quantity of silicone resin injected into each mold cavity 51 of the mold die member 11 may range from about 1 to 150 grams. In a preferred embodiment with complicated three-dimensional graphic designs onto clothing, the quantity of silicone resin injected into each mold ranges from about 1 to 75 grams. The desired quantity of thermosetting polymer resin selected for injection into each mold cavity 51 of the mold die member 11 will vary as a function of the particular three-dimensional design selected for placement onto a substrate.

Continuing the start-up procedure, the operator then positions and aligns the substrate upon the back plate 6A or 6B and then initiates the molding cycle.

Under control of the PLC 13, the molding cycle consists of initializing air cylinders 4A and 4B, lowering the die set 75, initializing the air cylinders 24A or 24B, moving the back plate 6A or 6B into the predetermined position, starting the injection of silicone resin supplies 21, stopping injection of silicone resin supplies 21, raising the die set 75, moving the die set 75 horizontally to the location of the next back plate 6B or 6A, moving the back plate 6A or 6B horizontally away from strike zone of the die set 75, removing the completed substrate, and automatically restarting the cycle after another substrate is deposited on the back plate 6A or 6B. Upon initiating the molding cycle, the silicone resin, or other thermosetting polymer resin, supply system 80 will load one or more silicone resin injection pumps 26 with the predetermined quantities of silicone resin, or other thermosetting polymer resin, to be injected. Alternatively, a mixture of different thermosetting polymer resin supplies may be provided that will permit three-dimensional bodies of a plurality of thermosetting polymer resins of multiple colors to be molded onto a substrate.

During the step of lowering the die set 75, the hydraulic actuator 1 controllably lowers the die set 75 into position with the garment 57, which is located and aligned upon the back plate 6A or 6B. In a preferred embodiment, the operation of the hydraulic actuator 1 is controlled by the control system 90. In a particularly preferred embodiment, the position of the hydraulic actuator 1 as well as the contact pressure of the die set 75 with pressure sensor are monitored and controlled by the control system 90. Upon engagement of the die set 75 with the garment 57, the operational step of injecting silicone resin supplies 21 begins.

The operating pressure and flow rate of the silicone resin injected into the mold cavities 51 may be limited, for example, to the range of about 200 to 800 psig and 0.33 to 0.50 in³/sec in order to prevent damage to the article of clothing. In a particularly preferred embodiment, the operating pressure and flow rate of the silicone resin injected into the mold cavities 51 are limited to the range of about 300 to 600 psig and 0.01 to 0.33 in³/sec in order to prevent damage to the article of clothing. Alternatively, the preferred range of operating pressures and flow rates will vary as a function of the type and thickness of the substrate.

The curing of the silicone resin supplies 21 is integrated in the heat transfer process and the silicone continues to cure, after the injection cycle is complete, in a conventional way. During the injection cycle, the die set 75 is maintained in engagement with the article of clothing 57, or other substrate, within an air gap 50 for a predetermined time period to allow the graphic design to be completely delivered for the fully predetermined amount of silicone resin, or some other thermosetting polymer resin, in a place as the article of clothing 57, or other substrate is positioned and aligned. For typical types and grades of silicone resin, the curing time and temperature may range, for example, from approximately 5 to 50 seconds and 200° to 500° F. In a preferred embodiment, the heat transfer occurs within time and temperatures range from about 10 to 30 seconds and 300° to 900° F. The heat transfer times and temperatures will vary as a function of the particular type of thermosetting polymer selected as well as the number and volume of the mold cavities 51 of the mold die member 11. Once the silicone resin, or other thermosetting polymer resin is fully deposited according to a predetermined graphic design, the die set 75 is raised out of engagement with the article of clothing 57, or other substrate.

During the step of raising the die set 75, the hydraulic actuator 1 controllably raises the die set 75 out of engagement with the article of clothing 57, or other substrate and the air cylinders 4A and 4B controllably transport the die set 75 horizontally to engage the next article of clothing 57 or substrate. The control system 90 then once again initiates the molding cycle.

In the preferred embodiment, the flow of silicone resin into the die set 75 can be timely stopped by using flow control valves, which can be closed within a time period ranging from about 125 to 500 msec and injection pumps 26A, 26B, 26C, 26D and 26E.

In a particularly preferred embodiment, the operational steps described above are all controlled and monitored by the control system 90. Alternatively, the operational steps described above are implemented using any number of thermosetting polymers including, for example, silicone, nitrile rubber or urethane. Furthermore, the operational steps described above are implemented using a combination of different thermosetting polymers having similar curing characteristics, including such combinations as, for example, silicone, nitrile rubber or urethane.

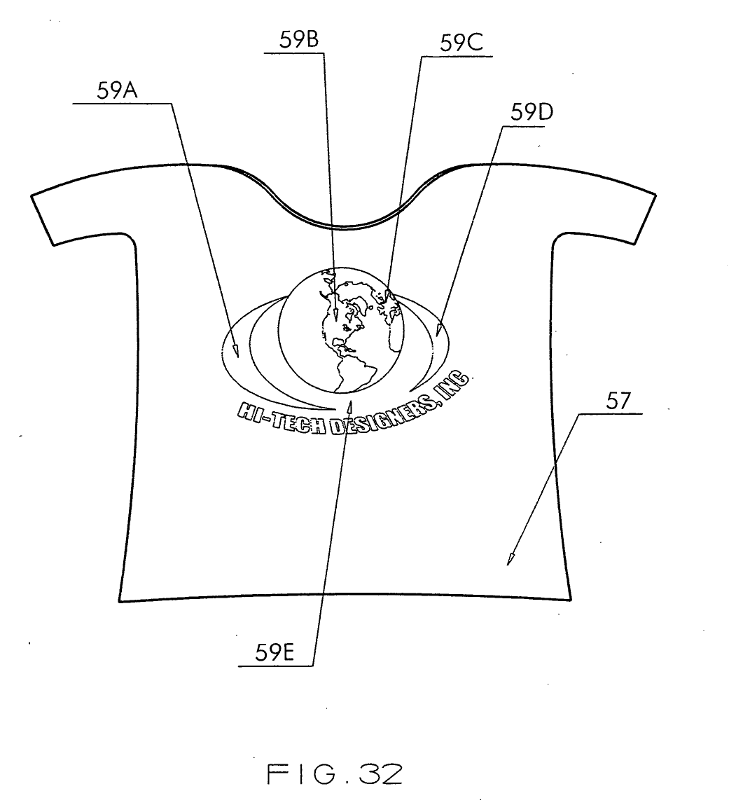

Drawing FIG. 32 illustrates a preferred embodiment of an article of clothing 57 including one or more three-dimensional bodies of silicone, or other thermosetting polymer 59A, 59B, 59C, 59C, 59D and 59E. The article of clothing 57 includes a T-shirt, or other similar garment such as a cap, or purse and at least one three-dimensional body of silicone, or other thermosetting polymer, 21, molded onto the T-shirt 57, or other garment. The article of clothing 57 includes a plurality of three-dimensional bodies of silicone, or other thermosetting polymers 59A, 59B, 59C, 59D and 59E. In a particularly preferred embodiment, the three-dimensional bodies of silicone, or other thermosetting polymers, 21 are molded onto the T-shirt 57, or other garment, using the apparatus 60 and accompanying methods described above. Using this approach, a plurality of multi-colored three-dimensional bodies of silicone can be molded onto a plurality of T-shirts 57, or other garments, substantially simultaneously and continuously. More generally, the T-shirt 57 or other garment, may comprise any substrate and a plurality of three-dimensional multi-colored bodies of the same or different thermosetting polymers may be molded onto the substrate using the apparatus 60 and accompanying methods described above.

The three-dimensional bodies of silicone 59, or some other thermosetting polymer, are preferably molded onto a T-shirt 57, or some other substrate, by adhesion as the silicon resin or some other thermosetting polymers are injected under pressure onto the fibers of the T-shirt 57, or some other garment or substrate to create a bond at the surfaces of contact of the T-shirt 57 and the silicone resin supplies 21. In this manner, the three-dimensional bodies of silicone 59, or some other thermosetting polymer, are permanently affixed to the T-shirt 57, or some other garment or substrate as the polymers cool and solidify the bonding surfaces. The bonding surfaces are formed on the outside surface of the fabric of the T-shirt 57 or some other garment or substrate and the corresponding contact surface of the graphic design.

In a particularly preferred embodiment, one or more of the three-dimensional bodies of silicone, or some other thermosetting polymer, 59, may further include at least one encapsulated element such as a beeper, liquid crystal display, holograph, or other device. In a particularly preferred embodiment, the encapsulated device is a computer chip, granular fill material, paper or cardboard.

An apparatus and operational steps for molding three-dimensional bodies of silicone, or some other thermosetting polymer, onto articles of clothing, or other substrates, have been described. The operations of the apparatus are substantially controllable and programmable using input signal from sensors and output signal from the PLC 13 to initiate actuators and injection cycle. The apparatus further permits a plurality of three-dimensional bodies of silicone, or some other thermosetting polymer, that are of a plurality of colors to be molded onto an article of clothing, or other substrates.

The apparatus further permits a plurality of such three-dimensional bodies to be molded onto a plurality of substrates substantially simultaneously and continuously. The apparatus may be generally applied to the molding of three-dimensional bodies of thermosetting polymers onto substrates. The apparatus may be further applied to form a plurality of three-dimensional bodies of a plurality of types of thermosetting polymers onto substrates.

A molding device has been described for molding three-dimensional bodies of silicone, or some other thermosetting polymer, onto an article of clothing, or some other substrate, which is controllably movable to lower, raise and horizontally transport itself to inject silicone resin or any other thermosetting polymer to substrates located on back plates being controllably movable and positioned side by side. The molding device permits at least one three-dimensional body of silicone, or some other thermosetting polymer, to be molded onto an article of clothing, or some other substrate substantially continuously. More generally, the molding device may be used to mold any thermosetting polymer onto a substrate. More generally still, the molding device may be used to mold a plurality of different types of thermosetting polymers onto a substrate. The molding device has included a number of elements to cure silicone resin by the heat transfer process in contact, or other thermosetting polymer resins, within the die set of the molding device and to avoid silicone resin dripping. The molding device may be generally applied to the molding of three-dimensional bodies of thermosetting polymers onto substrates.

A die set has been described that provides an receiving die member, thermal isolation member, and a mold die member, which are substantially interconnected rigidly and aligned, for use in a molding device. The die set is utilized to mold and deliver cured three-dimensional bodies of silicone, or other thermosetting polymers, onto substrates.

A silicone resin supply has been described that provides a plurality of supplies of silicone resin, or some other thermosetting polymer resin, for subsequent injection into at least one molding device.

The apparatus described herein may be used to create articles of clothing, or some other substrate, having at least one three-dimensional body of silicone, or some other thermosetting polymer. The apparatus described herein may further be used to create articles of clothing, or some other substrate, having at least one three-dimensional body of silicone, or some other thermosetting polymer, that further includes at least one encapsulated element.

While described in the form of preferred embodiments for molding three-dimensional bodies of silicone, with and without encapsulated elements, the teachings of the present disclosure will find broad application to molding three-dimensional bodies of thermosetting polymers, with and without encapsulated elements, onto substrates generally.

1. A die set with a plurality of die members for use in an injection device for molding at least one three-dimensional body of a thermosetting polymer onto at least one substrate, comprising:
a die holder having a top end and a bottom end;
said bottom end is adapted to cooperatively couple with said die members;
a receiving die member adapted to receive and distribute at least one supply of said polymer;
a mold die member including at least one cavity coupled connectively to said receiving die member and adapted to receive said distribution of at least one of said supply of said polymer and mold at least one of said three-dimensional bodies of said polymer onto at least one of said substrate;
a thermal isolation die member located adaptively between said receiving die member and said mold die member;
at least one rigid guide means coupled internally to the die members for cooperatively positioning the die members;
at least one fastener interconnecting said receiving die member, said thermal isolation member and said mold die member; and
at least one injection nozzle with removable injection nozzle tip internally connected through said die members, and adapted to receive and distribute a diverse type of said polymer.

2. The die set of claim 1, wherein said receiving die member is adapted to receive and distribute a plurality of supplies of said polymer, and said mold die member includes a plurality of cavities and is adapted to receive said distribution of said plurality of supplies of said polymer and mold said plurality of supplies of said polymer onto at least one of said substrate to form a plurality of three-dimensional bodies of said polymer.

3. The die set of claim 2, wherein said die set is controllably movable to position said mold die member for injecting said polymer onto substrates by transport means interactively connected to a programmable logic controller.

4. The die set of claim 3, wherein said die set further includes at least one thermocouple coupled to said thermal isolation element coupled between said input member and said mold die member.

5. The die set of claim 4, wherein said receiving die member includes a cooling element adapted to maintain a temperature of said receiving die member within a predetermined range of temperatures.

6. The die set of claim 5, wherein said receiving die member includes at least one flow control valve adapted to controllably couple said receiving die member to at least one of said supplies of said polymer.

7. The die set of claim 7, wherein said flow control valve is controllable and adapted to said programmable logic controller.

8. The die set of claim 1, wherein said receiving die member includes at least one injection pump adapted to controllably couple said member to either one of at least one of said supplies of said polymer.

9. The die set of claim 8, wherein said receiving die member includes at least one injection pump adapted to controllably couple said member to said programmable logic controller.

10. The die set of claim 9, wherein said receiving die member includes at least one nozzle adapted to cooperatively interact with said programmable logic controller and distribute at least one of said supplies of said polymer to said die mold member.

11. The die set of claim 10, wherein said die set is adaptably coupled to controllable air cylinders.

12. The die set of claim 11, wherein said die mold member includes a heating member adapted to controllably maintain a temperature of said mold within a predetermined range of temperatures.

13. The die set of claim 1, wherein each mold cavity is at least partially defined by a portion extending outward from said mold.

14. The die set of claim 1, wherein said receiving input member comprises:
a manifold adapted to receive at least one of said supplies of said polymer; and
a receiving die member coupled to said manifold and adapted to distribute at least one of said supplies of said polymer.

15. The die set of claim 1, wherein at least one of said supplies of said polymer comprises a supply of a first polymer and a supply of a second polymer.

16. The die set of claim 1, wherein said die set is adapted to mold a plurality of three-dimensional bodies of thermosetting polymer onto a plurality of substrates substantially simultaneously.

17. The die set of claim 1, wherein said die set is adapted to mold a plurality of three-dimensional bodies of thermosetting polymer onto a substrate using a plurality of different types of thermosetting polymers.
